(19) United States
(12) Patent Application Publication
(10) Pub. No.: US 2023/0171655 A1
(43) Pub. Date: Jun. 1, 2023

(54) Method Network Optimization in Handover Failure Scenarios

(71) Applicant: GOOGLE LLC, Mountain View, CA (US)

(72) Inventor: Teming Chen, Taoyuan City (TW)

(21) Appl. No.: 17/922,597

(22) PCT Filed: Apr. 28, 2021
(86) PCT No.: PCT/US21/29659

§ 371 Date: Oct. 31, 2022

Related U.S. Application Data
(60) Provisional application No. 63/018,499, filed on Apr. 30, 2020.

(51) Int. Cl. H04W 36/00; H04W 36/30

(52) U.S. Cl. CPC H04W 36/0079; H04W 36/305

(57) ABSTRACT

Processing hardware in a user equipment (UE) can implement a method for supporting a dual active protocol stack (DAPS) handover in a UE connected to a first base station of a radio access network (RAN). The method includes attempting to connect to a second base station of the RAN during the DAPS handover (2102). The method also includes detecting a potential failure associated with a radio connection to the first base station (2104) and detecting a failure to connect to the second base station (2106). Further, the method includes initiating a procedure to re-establish the radio connection and transmitting, to the RAN, a radio link failure report including an indication of the failure to connect to the second base station.

This disclosure relates generally to wireless communications and, more particularly, to managing network optimization and failure reporting in handover failure scenarios.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The evolution of wireless communication to fifth-generation (5G) standards and technologies provide higher data rates and greater capacity, with improved reliability and lower latency, which enhances mobile broadband services. 5G technologies also provide new classes of services for vehicular, fixed wireless broadband, and the Internet of Things (IoT). The specification of the features in the 5G air interface is defined as 5G New Radio (5G NR).

To communicate wirelessly with a radio access network (RAN), a user equipment (UE) may establish a connection to the RAN via at least one network node (e.g., a base station or a serving cell) that supports a fifth-generation core network (5GC). In some situations, the base stations (BS) can use a handover procedure to request that a UE connect to another BS. During a handover procedure, a UE can transition from a source BS to a target BS or cell without losing connection to the RAN. The source BS and the target BS nodes can be associated with a same radio access technology (RAT) or different RATs.

In telecommunication systems, the Packet Data Convergence Protocol (PDCP) sublayer of the radio protocol stack provides services such as transfer of user-plane data, ciphering, integrity protection, etc. For example, the PDCP layer defined for the Evolved Universal Terrestrial Radio Access (EUTRA) radio interface (see 3GPP TS 36.323) and New Radio (NR) (see TS 38.323) provides sequencing of protocol data units (PDUs) in the uplink direction (from a user equipment (UE) to a base station) as well as in the downlink direction (from the base station to the UE). Further, the PDCP sublayer provides signaling radio bearers (SRBs) and data radio bearers (DRBs) to the Radio Resource Control (RRC) sublayer. Generally speaking, the UE and a base station can use SRBs to exchange RRC messages as well as non-access stratum (NAS) messages and use DRBs to transport data on a user plane.

Various errors can occur in the radio links between the UE and the RAN and during procedures the UE and the RAN perform to hand over the UE from one base station to another. Generally speaking, the UE reports different kinds of errors to the RAN using different error codes. However, in some cases, existing error reporting schemes do not result in the UE accurately reporting errors to the RAN.

In particular, existing techniques do not always clearly specify errors detected during handover procedures, such as dual active protocol stack (DAPS) handovers and inter-RAT handovers. As a result of sub-optimal error reporting during these scenarios, the network may perform error mitigation techniques (e.g., Mobility Robustness Optimization (MRO)) that do not address the problems the UE detected.

### SUMMARY

A UE and/or a base station of this disclosure can manage errors in scenarios that involve DAPS handovers or inter-RAT handovers so as to support network optimization.

For example, during a dual active protocol stack (DAPS) handover, a UE connected to a base station attempts to connect to a target base station while maintaining the connection with the original base station. The UE can detect problems both with connecting to the target base station and in the connection with the original base station. A UE of this disclosure mitigates the interaction of these errors and reduces incomplete or inaccurate error reporting to the network, and thereby helps the network address the DAPS handover failure.

As another example, a UE connected to a cell of a first radio access technology (RAT) (e.g., a fourth-generation (4G) RAT) attempts to connect to a cell of a second RAT (e.g., a fifth-generation (5G) RAT) via an inter-RAT handover. If the UE is unable to complete the handover, the UE may report a handover failure. Whereas existing techniques do not always clearly specify the reason for the handover failure, a UE of this disclosure reports the reason (e.g., a failure to apply a configuration in a handover request) that allows the RAN to properly process the failure.

In some scenarios, a UE of this disclosure initially operates in connection with a base station and attempts to connect to a target base station during a DAPS handover. If the UE detects a DAPS handover failure (i) while a timer is running that the UE starts in response to detecting a synchronization problem with the connection with the (source) base station or (ii) before detecting a radio failure, the UE can report the DAPS handover failure by transmitting an RRCReestablishmentRequest to the base station including a failure cause corresponding to a handover failure. Alternatively, if the UE transmits an RRCReestablishmentRequest including a failure cause corresponding to a radio link failure (RLF), a base station of this disclosure can still determine whether the UE detected a DAPS handover failure. If the base station previously transmitted a DAPS handover configuration to the UE, and has not received an indication that the handover either succeeded or failed, the base station can determine that the UE detected a DAPS handover failure, and can perform network optimization accordingly.

In other scenarios, the UE initially operates in connection with a base station via a first cell and attempts to connect to a second cell associated with a different RAT. If the UE is unable to apply a configuration associated with the second cell, the UE transmits an RRCReestablishmentRequest to the base station including a failure cause corresponding to a reconfiguration failure. Alternatively, if the UE instead transmits an RRCReestablishmentRequest including a failure cause corresponding to handover failure, a base station of this disclosure can still determine whether the UE was unable to apply the configuration. If the base station later receives an indication that handover information is not available at the UE, the base station can determine that the UE was unable to apply the configuration, and can take appropriate corrective action.

An example embodiment of the techniques of this disclosure is a method for supporting a DAPS handover in a UE connected to a first base station of a RAN. The method is implemented by processing hardware and includes attempting to connect to a second base station of the RAN during the DAPS handover. The method also includes detecting a potential failure associated with a radio connection to the first base station and detecting a failure to connect to the second base station. Further, the method includes initiating a procedure to re-establish the radio connection, the initiating including providing, to the RAN, an indication of the failure to connect.

Another example embodiment of these techniques is a method, in a UE connected to a first cell associated with a RAT, for supporting a handover to a second cell associated with a second RAT. The method is performed by processing hardware and includes attempting to connect to the second cell and detecting a failure to apply a configuration associated with the second cell. The method also includes providing an indication of the failure to apply the configuration via the first cell.

Yet another example embodiment of these techniques is a UE including processing hardware and configured to execute the methods above.

A further example embodiment of these techniques is a method in a first base station in communication with a UE via a radio link. The method is implemented by processing hardware and includes transmitting a configuration according to which the UE is to connect to a second base station during a DAPS handover procedure. The method also includes receiving an indication that the UE detected a failure of the radio link. Further, the method includes determining that the UE detected a failure to connect to the second base station, and performing a network optimization procedure based on the determining.

Another example embodiment of these techniques is a method for supporting an inter-RAT handover in a base station supporting a first cell of a first RAT. The method is performed by processing hardware and includes transmitting, to a user equipment (UE), a request for the UE to connect to a second cell of a second RAT. The request includes a configuration the UE is to use to connect to the second cell. The method also includes receiving a request from the UE to re-establish a radio connection, the request including a failure cause indicating a handover failure. Further, the method includes transmitting a message to configure a radio connection with the UE and receiving a response to the message, the response indicating that handover failure information is not available. Still further, the method includes determining that the UE was unable to apply the configuration and performing a corrective action in response to the determining.

Yet another example embodiment of these techniques is a base station including processing hardware and configured to execute the methods above.

### BRIEF DESCRIPTION OF THE DRAWINGS

FIG. 1 is a block diagram of an example system in which a radio access network (RAN) and a user equipment can implement the techniques of this disclosure for managing network optimization in handover failure scenarios;

FIG. 2 is a block diagram of an example protocol stack according to which the UE of FIG. 1 communicates with base stations;

FIG. 3 is a block diagram of an example scenario in which the UE communicates failure information to base stations of the RAN;

FIG. 4 is a messaging diagram of an example scenario in which a UE successfully completes a handover from a base station (BS) to a target base station (T-BS) in accordance with a dual active protocol stack (DAPS) configuration;

FIG. 5 is a messaging diagram of an example scenario in which a UE detects a DAPS handover failure after detecting a synchronization problem in the radio link with the BS and before detecting an RLF;

FIG. 6 is a messaging diagram of an example scenario in which a UE detects an RLF after detecting a DAPS handover failure;

FIG. 7 is a messaging diagram of another example scenario in which a UE detects an RLF after detecting a DAPS handover failure;

FIG. 8 is a messaging diagram of an example scenario in which a BS that previously transmitted a DAPS configuration to a UE receives an RRCReestablishmentRequest from the UE indicating a failure cause corresponding to otherFailure;

FIG. 9 is a messaging diagram of an example scenario in which a BS that previously transmitted a DAPS configuration to a UE receives a failure report from another BS indicating that the UE transmitted an RRCReestablishmentRequest indicating a failure cause corresponding to otherFailure;

FIG. 10 is a flow diagram of an example method including detecting a DAPS handover failure before detecting a RLF, which can be implemented in a UE of this disclosure;

FIG. 11 is a flow diagram of an example method including detecting a DAPS handover failure while a timer the UE starts in response to detecting a synchronization problem is running, which can be implemented in a UE of this disclosure;

FIG. 12 is a flow diagram of an example method including initializing an RRC re-establishment procedure in response to failing to successfully transmit a failure information message indicating a DAPS handover failure, which can be implemented in a UE of this disclosure;

FIG. 13 is a flow diagram of an example method including performing network optimization based on a failure cause received in a request from a UE to re-establish a radio connection, which can be implemented in a base station of this disclosure;

FIG. 14 is a flow diagram of an example method including performing network optimization based on a failure cause received in a failure report from another base station, which can be implemented in a base station of this disclosure;

FIG. 15 is a messaging diagram of an example scenario in which a UE fails to apply an intra-RAT handover configuration;

FIG. 16 is a messaging diagram of an example scenario in which a UE fails to apply an inter-RAT handover configuration;

FIG. 17 is a messaging diagram of another example scenario in which a UE fails to apply an inter-RAT handover configuration;

FIG. 18 is a flow diagram of an example method including initializing an RRC re-establishment procedure based on detecting a failure to apply an inter-RAT handover configuration, which can be implemented in a UE of this disclosure;

FIG. 19 is a flow diagram of another example method including initializing an RRC re-establishment procedure based on detecting a failure to apply an inter-RAT handover configuration, which can be implemented in a UE of this disclosure;

FIG. 20 is a flow diagram of an example method including determining a UE detected a failure to apply an inter-RAT handover configuration, which can be implemented in a base station of this disclosure;

FIG. 21 is a flow diagram of an example method for supporting a DAPS handover, which can be implemented in a UE of this disclosure;

FIG. 22 is a flow diagram of an example method for network optimization in a scenario involving a DAPS handover, which can be implemented in a base station of this disclosure;

FIG. 23 is a flow diagram of an example method for supporting an inter-RAT handover, which can be implemented in a UE of this disclosure; and

FIG. 24 is a flow diagram of an example method for network optimization in a scenario involving an inter-RAT handover, which can be implemented in a base station of this disclosure.

### DETAILED DESCRIPTION OF THE DRAWINGS

Generally speaking, the communication devices of this disclosure implement procedures related to dual active protocol stack (DAPS) handover procedures and inter-RAT handover procedures. In a DAPS handover procedure, as discussed below, a base station (BS) can configure a UE to handover to a target base station (T-BS) using a DAPS configuration. After the UE successfully completes the handover to the T-BS, the T-BS configures the UE to release the connection between the UE and the BS. If the UE is unable to connect to the T-BS, the UE reverts to the original configuration and remains connected with the original BS. In one implementation, releasing the connection can include: resetting a medium access control (MAC) protocol and releasing the MAC configuration, releasing the SRB/DRB radio link control (RLC) entity and the associated logical channel, reconfiguring the DRB PDCP entity to normal PDCP, releasing the SRB PDCP entity, releasing the physical channel configuration, or discarding keys (a KgNB, S-KgNB, S-KeNB, KRRCenc, KRRCint, KUPint, and/or KUPenc key). An inter-RAT handover is a handover from one radio access technology (RAT) to another (e.g., from a fourth-generation (4G) RAT to a fifth-generation (5G) RAT, or vice versa).

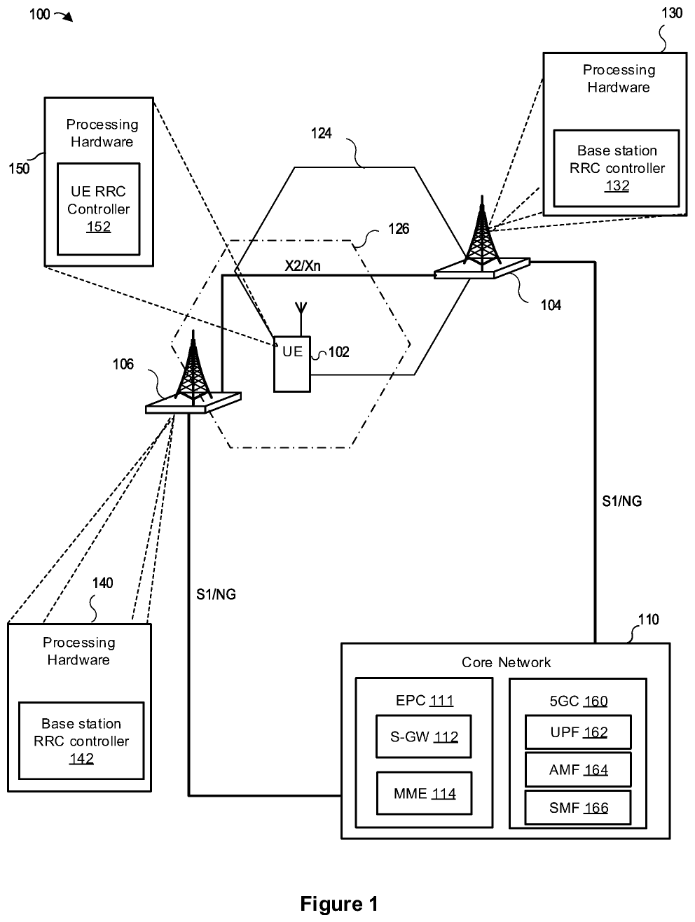

FIG. 1 depicts an example wireless communication system 100 in which communication devices can implement the techniques of this disclosure. The wireless communication system 100 includes a UE 102, a base station 104, a base station 106, and a core network (CN) 110. In the scenarios discussed in this disclosure, the UE 102 initially connects to the base station 104.

In some scenarios, the base station 104 can perform an immediate handover preparation procedure to configure the UE 102 to execute a handover from a cell 124 of the base station 104 to a cell 126 of the base station 106 (target BS, or “T-BS”). During an immediate handover, the UE 102 disconnects from the BS 104 and attempts to connect to the T-BS 106.

In other scenarios, the base station 104 can perform a DAPS handover preparation procedure to configure the UE 102 to execute a handover from a cell 124 of the base station 104 to a cell 126 of the base station 106 (target BS, or “T-BS”). In contrast to the immediate handover case discussed above, the UE 102 does not immediately disconnect from the BS 104. In this scenario, the UE 102 disconnects from the BS 104 after the UE 102 connects to the T-BS 106. More particularly, when the UE 102 receives a configuration for the T-BS 106, the UE 102 does not disconnect from the BS 104 until the UE 102 has received a disconnection configuration from T-BS 106.

The base stations 104 and 106 can be any suitable type, or types, of base stations, such as an evolved node B (eNB), a next-generation eNB (ng-eNB), or a 5G Node B (gNB), for example. The UE 102 can communicate with the base station 104 and the base station 106 via the same RAT, such as EUTRA or NR, or different RATs. The base station 104 supports a cell 124, and the base station 106 supports a cell 126. The cell 124 partially overlaps with the cell 126, such that the UE 102 can be in range to communicate with the base station 104 while simultaneously being in range to communicate with the base station 106 (or in range to detect or measure the signal from the base station 106). The overlap can make it possible for the UE 102 to hand over between cells (e.g., from the cell 124 to the cell 126) or base stations (e.g., from the base station 104 to the base station 106). As another example, the UE 102 can communicate in dual connectivity (DC) with the base station 104 (operating as an MN) and the base station 106 (operating as an SN).

The base stations 104 and 106 can connect to the same core network (CN) 110 which can be an evolved packet core (EPC) 111 or a fifth-generation core (5GC) 160. The base station 104 can be implemented as an eNB supporting an S1 interface for communicating with the EPC 111, an ng-eNB supporting an NG interface for communicating with the 5GC 160, or as a gNB that supports the NR radio interface as well as an NG interface for communicating with the 5GC 160. The base station 106 can be implemented as an eNB with an S1 interface to the EPC 111, an ng-eNB that does not connect to the EPC 111, a gNB that supports the NR radio interface as well as an NG interface to the 5GC 160, or a ng-eNB that supports an EUTRA radio interface as well as an NG interface to the 5GC 160. To directly exchange messages during the scenarios discussed below, the base stations 104 and 106 can support an X2 or Xn interface.

Among other components, the EPC 111 can include a Serving Gateway (S-GW) 112 and a Mobility Management Entity (MME) 114. The S-GW 112 is generally configured to transfer user-plane packets related to audio calls, video calls, Internet traffic, etc., and the MME 114 is configured to manage authentication, registration, paging, and other related functions. The 5GC 160 includes a User Plane Function (UPF) 162 and an Access and Mobility Management (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

In general, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure also can apply to other suitable radio access and/or core network technologies such as sixth generation (6G) radio access and/or 6G core network or 5G NR-6G DC, for example.

With continued reference to FIG. 1, the base station 104 is equipped with processing hardware 130 that can include one or more general-purpose processors (e.g., central processing units (CPUs)) and a non-transitory computer-readable memory storing machine-readable instructions executable on the one or more general-purpose processor(s), and/or special-purpose processing units. The processing hardware 130 in an example implementation includes a base station RRC controller 132 configured to manage or control one or more RRC configurations or RRC procedures. For example, the base station RRC controller 132 can be configured to support RRC messaging associated with DAPS and/or inter-RAT handovers, and to support the techniques discussed below.

The base station 106 is equipped with processing hardware 140 that can also include one or more general-purpose processors, such as CPUs, and a non-transitory computer-readable memory storing machine-readable instructions executable on the one or more general-purpose processors, and/or special-purpose processing units. The processing hardware 140 in an example implementation includes a base station RRC controller 142, which may be similar to the base station controller 132.

Still referring to FIG. 1, the UE 102 is equipped with processing hardware 150 that can include one or more general-purpose processors, such as CPUs, and a non-transitory computer-readable memory storing machine-readable instructions executable on the one or more general-purpose processors, and/or special-purpose processing units. The processing hardware 150 in an example implementation includes a UE RRC controller 152 configured to manage or control one or more RRC configurations and/or RRC procedures. For example, the UE RRC controller 152 can be configured to support RRC messaging associated with DAPS and/or inter-RAT handovers, and to support the techniques discussed below.

In operation, the UE 102 can use a radio bearer (e.g., a DRB or an SRB) that at different times terminates at the base station 104 or the base station 106. The UE 102 can apply one or more security keys when communicating on the radio bearer, in the uplink (from the UE 102 to a base station) and/or downlink (from a base station to the UE 102) direction.

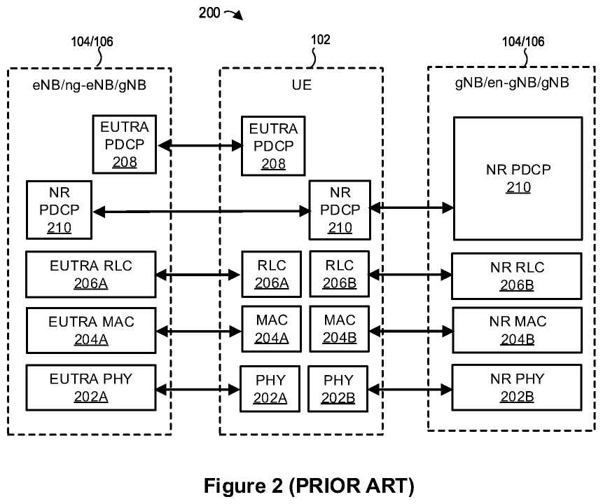

Next, FIG. 2 illustrates, in a simplified manner, an example radio protocol stack 200 according to which the UE 102 can communicate with an eNB/ng-eNB or a gNB (e.g., one or more of the base stations 104 and 106). The physical layer (PHY) 202A of EUTRA provides transport channels to the EUTRA Medium Access Control (MAC) sublayer 204A, which in turn provides logical channels to the EUTRA Radio Link Control (RLC) sublayer 206A. The EUTRA RLC sublayer 206A in turn provides RLC channels to the EUTRA PDCP sublayer 208 and, in some cases, to the NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides RLC channels to the NR PDCP sublayer 210. The UE 102 in some implementations supports both the EUTRA and the NR stack in order to support handover between EUTRA and NR base stations and/or to support DC over EUTRA and NR interfaces. Further, as illustrated in FIG. 2, the UE 102 can support layering of the NR PDCP sublayer 210 over the EUTRA RLC sublayer 206A.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 provide SRBs to exchange RRC messages, for example. On a user plane, the EUTRA PDCP sublayer 208 and the NR PDCP sublayer 210 provide DRBs to support data exchange.

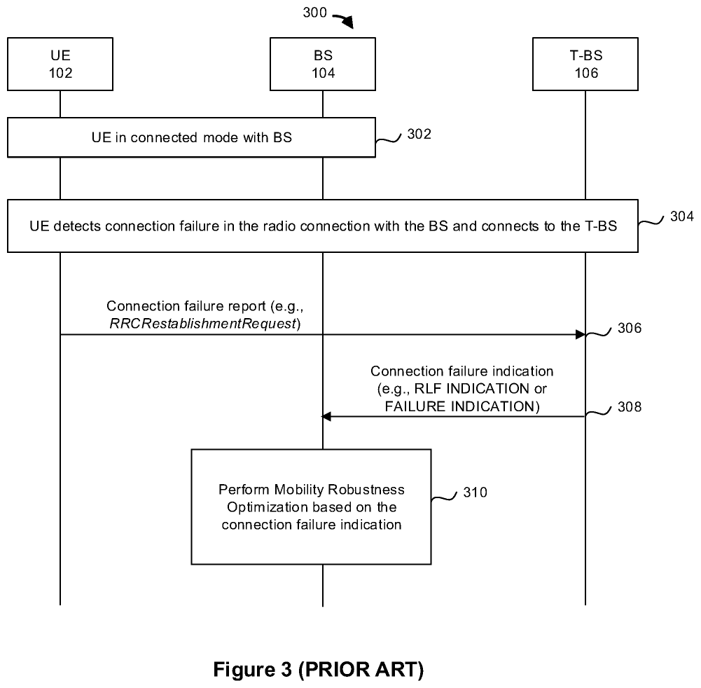

Next, FIG. 3 illustrates a messaging sequence during an example scenario 300 in which the UE 102 communicates failure information to the base stations 104 and 106 of the RAN, in accordance with known techniques. The base station 104 operates as a source base station, and the base station 106 operates as a target base station (T-BS). Initially, the UE operates 302 in connected mode with the BS 104. At a later time, the UE 102 detects 304 a connection failure in the radio connection with the BS 104 and decides to connect to the T-BS 106.

In response to the detection, the UE 102 transmits 306 a connection failure report to the T-BS 106. In one example, the connection failure report is an RRCReestablishmentRequest message including a reestablishment cause indicating the cause of the failure (e.g., handoverFailure to indicate that the UE 102 detected a handover failure, or otherFailure to indicate that the UE 102 detected an RLF). This disclosure also refers to this reestablishment cause as a failure cause. In another example, the connection failure report is a FailureInformation message including a failure indication (e.g., a failureType set as daps-failure).

The T-BS 106 then transmits 308 a connection failure indication to the BS 104. In one example, the connection failure indication is an RLF INDICATION message (e.g., if the T-BS 106 is an eNB) or a FAILURE INDICATION message (e.g., if the T-BS 106 is a gNB). The T-BS 106 includes a failure cause (e.g., an RRC Conn Reestab Indicator, a UE RLF Report Container, or other indication of handover failure, radio link failure, or conditional handover failure) in the connection failure indication.

According to the connection failure indication (e.g., based on whether the failure cause is handover failure, radio link failure, or other failure), the BS 104 performs Mobility Robustness Optimization (MRO). In one example, if the failure cause is radio link failure or other failure, the BS 104 determines that the handover attempt was too late. The BS 104 can adjust the measurement configurations for the UE 102 and other UEs in response to the MRO. In one implementation, the BS 104 may increase the threshold in “Event A2 (Serving becomes worse than threshold).” As a result of this change, the UE 102 reports this event earlier. In another implementation, the BS 104 may decrease the offset in “Event A3 (Neighbour becomes offset better than SpCell), and as a result, the UE 102 reports this event earlier.

In another example, if the failure cause is handover failure, the BS 104 determines that the handover attempt was too early. The BS 104 can adjust the measurement configurations for the UE 102 and other UEs in response to the MRO. In one implementation, the BS 104 may decrease the threshold in “Event A2 (Serving becomes worse than threshold),” and as a result, the UE 102 reports this event later. In another implementation, the BS 104 may increase the offset in “Event A3 (Neighbour becomes offset better than SpCell), and as a result the UE 102 reports this event later.

In one example, the BS 104 and the T-BS 106 can be the same or different cell associated to the same base station, in which case there is no connection failure indication exchange between BS 104 and T-BS 106.

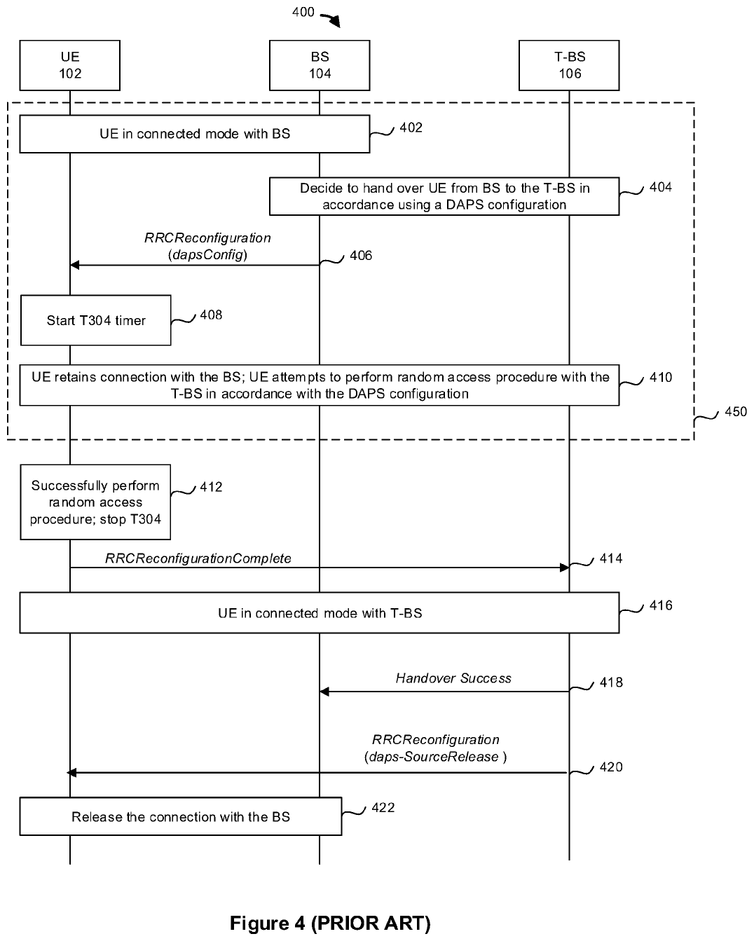

FIG. 4 illustrates a messaging sequence during an example scenario 400 in which the UE 102 successfully completes a DAPS handover from the BS 104 to the T-BS 106, in accordance with known techniques. Initially, the UE 102 operates 402 in connected mode with the BS 104. The BS 104 decides 404 to hand over the UE 102 to a T-BS 106 using a DAPS configuration. In response to this decision, the BS 104 transmits 406 an RRCReconfiguration message with a DAPS configuration (e.g., a dapsConfig) to the UE 102. In response to the RRCReconfiguration message, the UE 102 starts 408 a timer T304 and attempts 410 a random access procedure with the T-BS 106 in accordance with the DAPS configuration. During the random access procedure, the UE 102 retains 410 the connection with the BS 104. The timer T304 is used to track how long the UE 102 attempts to connect to the T-BS 104. If the timer T304 expires before the UE 102 successfully completes the handover to the T-BS 104, then the UE 102 detects a DAPS handover failure. While this disclosure generally refers to a “DAPS handover failure,” such an error is also sometimes referred to as a reconfiguration with sync failure. The events 402, 406, 408, and 410 are collectively referred to as a DAPS handover attempt procedure 450.

At a later time, the UE 102 successfully performs 412 the random access procedure with the T-BS 106. In response, the UE 102 stops 412 the timer T304 and transmits 414 an RRCReconfigurationComplete message to the T-BS 106. The UE 102 operates 416 in connected mode with the T-BS 106. In response to receiving the RRCReconfigurationComplete message, the T-BS 106 may transmit 418 a Handover Success message to the BS 104 and/or transmit 420 an RRCReconfiguration message including a DAPS release indication (e.g., a daps-SourceRelease) to the UE 102. The UE 102 then releases 422 the connection between it and the BS 104.

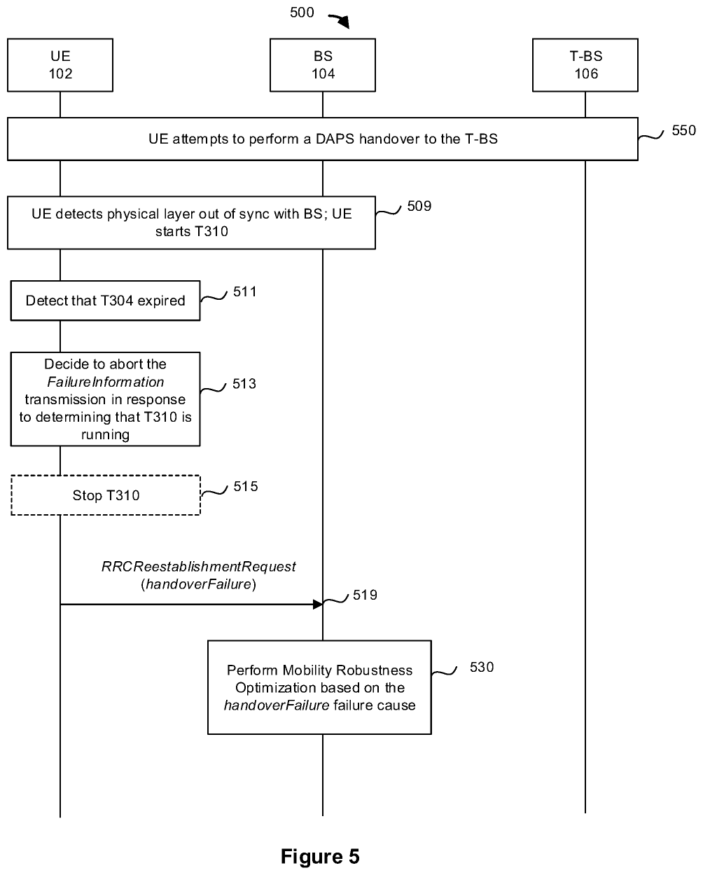

FIGS. 5-7 illustrate example messaging sequences corresponding to DAPS handover failure scenarios in which the UE 102 can use the techniques of this disclosure for supporting network optimization.

FIG. 5 illustrates a scenario 500 in which the base station 104 operates as a source base station, and the base station 106 operates as a target base station (T-BS). Initially, the UE 102 attempts 550 to perform a DAPS handover to the T-BS, similar to the DAPS handover attempt procedure 450. Before the UE 102 successfully performs a random access procedure with the T-BS 106, the UE detects 509 a synchronization problem in the radio connection with the BS 104 (e.g., detects that the PHY layer is out-of-sync) and starts 509 a timer T310 for the BS 104. After the UE 102 starts the timer T310 and before T310 expires, the UE 102 detects 511 that the timer T304 expires. In accordance with existing standards, after detecting that the timer T304 expires, the UE 102 transmits a FailureInformation message to indicate a DAPS handover failure. However, in scenario 500, the UE 102 checks whether timer T310 is running before transmitting a FailureInformation message. In response to the timer T304 expiring while the timer T310 is running, the UE 102 decides 513 to abort the FailureInformation message transmission. In one implementation, the UE 102 may stop 515 the timer T310 in response to the T304 expiring. The UE then 519 transmits an RRCReestablishmentRequest with a handoverFailure failure cause to the BS 104. In response, the BS 104 or the T-BS 106 performs 530 MRO based on the handover failure.

Thus, if the UE 102 detects that the timer T304 expires while the timer T310 is running, then the UE 102 initiates a connection re-establishment procedure rather than initiating a FailureInformation transmission. By initiating the re-establishment procedure, the UE 102 can set the failure cause (e.g., a reestablishmentCause) to indicate a handover failure (e.g., a reestablishmentCause corresponding to handoverFailure). In this way, the UE 102 informs the network of the DAPS handover failure, and the network can perform network optimization or other suitable corrective action in response.

In some implementations (not shown), the UE 102 performs cell selection to perform the RRC reestablishment procedure. The UE 102 may select a cell associated with a second BS, such as the T-BS 106, rather than with the BS 104. After selecting the cell associated with the second BS, the UE 102 transmits the RRCReestablishmentRequest to the second BS instead of transmitting the RRCReestablishmentRequest to the BS 104.

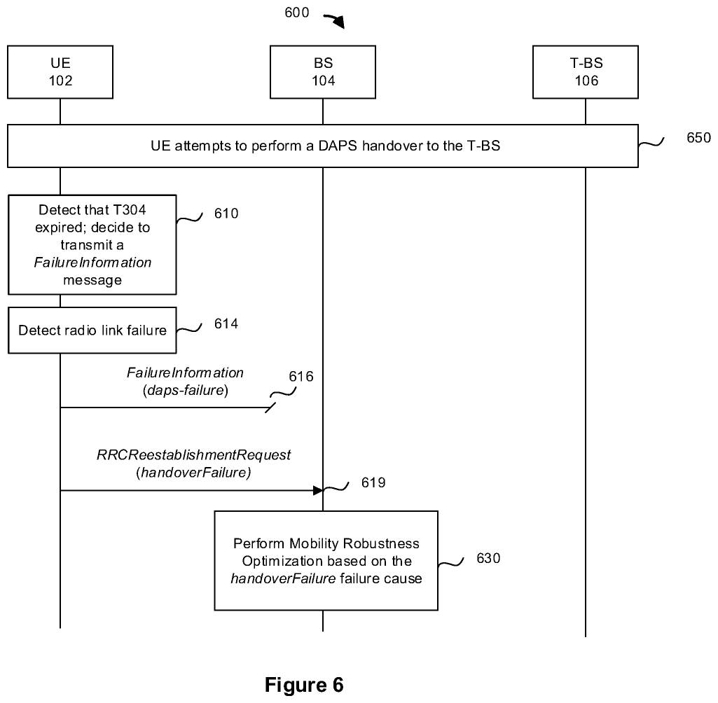

Next, FIG. 6 illustrates a scenario 600 in which the base station 104 operates as a source base station, and the base station 106 operates as a target base station (T-BS). Initially, the UE 102 attempts 650 to perform a DAPS handover to the T-BS, similar to the DAPS handover attempt procedure 450. Before the UE 102 successfully performs a random access procedure with the T-BS 106, the UE 102 detects 610 that the timer T304 expired and decides 610 to transmit a FailureInformation message to the BS 104 to indicate the DAPS failure. At a later time, a radio link failure (RLF) 614 interrupts the transmission of the FailureInformation message and the UE 102 is unable to successfully transmit 616 the FailureInformation message to the BS 104. If, after detecting a failure to transmit a FailureInformation message, the UE 102 were to set the failure cause to otherFailure or radio link failure, for example, the base station 104 could perform MRO incorrectly. In scenario 600, the UE 102 initiates a connection re-establishment procedure by indicating a failure cause corresponding to handover failure. More particularly, the UE 102 transmits 619 an RRCReestablishmentRequest message with cause handoverFailure to the BS 104. Accordingly, the BS 104 or T-BS 106 performs 630 MRO based on the handover failure rather than the later-occurring RLF.

Thus, if the UE 102 detects a failure to deliver a FailureInformation message indicating a DAPS failure, then the UE 102 initiates a connection re-establishment procedure by, for example, transmitting an RRCReestablishmentRequest with failure cause handoverFailure. In this way, the UE 102 informs the network of the DAPS handover failure, and the network can perform network optimization or other suitable corrective action in response.

The UE 102 can detect 614 the RLF in several ways. For example, the UE 102 detects an RLF due to detecting that an out-of-sync timer T310 or a link establishment timer T312 for the BS 104 expired. In some cases, the UE 102 may detect an RLF due to receiving a random access problem indication from the MAC layer for the BS 104, or due to receiving an indication from the RLC layer that the maximum number of retransmissions has been reached for the BS 104. If the UE 102 is connected as an Integrated Access and Backhaul (IAB) node, then the UE 102 can detect an RLF upon receiving a backhaul (BH) RLF indication on a Backhaul Adaptation Protocol (BAP) entity from the BS 104. Further, the UE 102 can detect an RLF upon receiving an indication of consistent uplink Listen Before Talk (LBT) failures from the MAC layer for the BS 104.

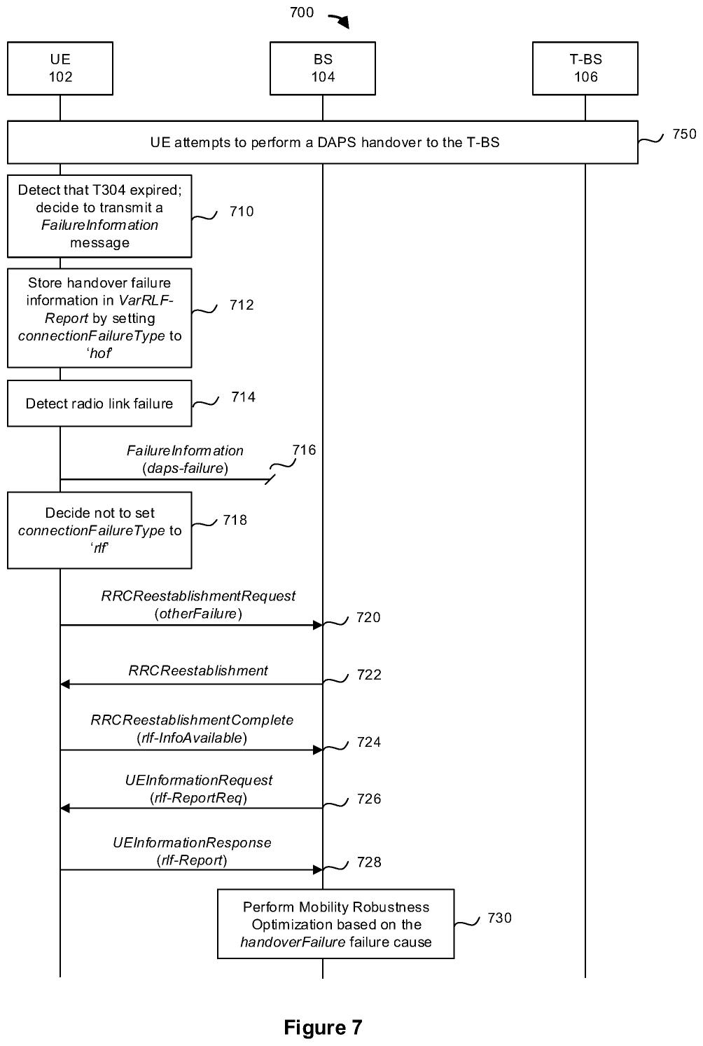

Next, FIG. 7 illustrates a scenario 700 in which the base station 104 operates as a source base station, and the base station 106 operates as a target base station (T-BS). Initially, the UE 102 attempts 750 to perform a DAPS handover to the T-BS, similar to the DAPS handover attempt procedure 450. Before the UE 102 successfully performs a random access procedure with the T-BS 106, the UE 102 detects 710 that the timer T304 expired and decides 710 to transmit a FailureInformation message to the BS 104 to indicate the DAPS failure. The UE 102 then stores 712 the DAPS handover failure information.

In one implementation, the UE 102 stores the handover failure information in a VarRLF-Report. The UE 102 can store the serving cell measurement result in a measResultLastServCell field or store the neighboring cell measurement results in a measResultNeighCells field of the VarRLF-Report. The UE 102 can also store the identity of the BS 104 and T-BS 106 (e.g., the C-RNTI or the PCI) in the VarRLF-Report. To indicate the handover failure, the UE 102 sets the connectionFailureType field to ‘hof’.

At a later time, a radio link failure (RLF) 714 interrupts the transmission of the FailureInformation message and the UE 102 is unable to successfully transmit 716 the FailureInformation message to the BS 104. In response to the RLF during the FailureInformation transmission (i.e., the DAPS failure indication transmission), the UE 102 decides 718 not to store the RLF information and performs the RRC reestablishment procedure with the network. In one implementation, the UE 102 stores the RLF information in VarRLF-Report after the RLF, but does not set the connectionFailureType to ‘rlf’ (e.g., by setting the connectionFailureType to ‘hof’ or keeping the connectionFailureType as ‘hof’).

The UE 102 then transmits 720 an RRCReestablishmentRequest message with cause otherFailure to the BS 104. In response to the RRCReestablishmentRequest, the BS 104 transmits 722 an RRCReestablishment message to the UE 102. After receiving the RRCReestablishment message, the UE 102 sends 724 an RRCReestablishmentComplete message to the BS 104 including an indication that handover failure information is available (e.g., a rlf-InfoAvailable). In one implementation, the BS 104 transmits an RRCSetup message to the UE 102 instead of the RRCReestablishment message. After receiving the RRCSetup message, the UE 102 sends 724 an RRCSetupComplete message to the BS 104 including an indication that handover failure information is available (e.g., a rlf-InfoAvailable).

In response to the indication that handover failure information is available, the BS 104 may transmit 726 a UEInformationRequest message to request the handover information (e.g., by including a rlf-ReportReq in the UEInformationRequest). The UE 102 then transmits 728 a UEInformationResponse message to the BS 104 to report the handover information (e.g., by including an rlf-Report in the UEInformationResponse). The rlf-Report indicates that the connection failure was due to a handover failure (e.g., because the connectionFailureType field is set to hof rather than rlf). Accordingly, the BS 104 or the T-BS 106 performs 730 Mobility Robustness Optimization based on a failure cause corresponding to a handover failure rather than the later-occurring RLF.

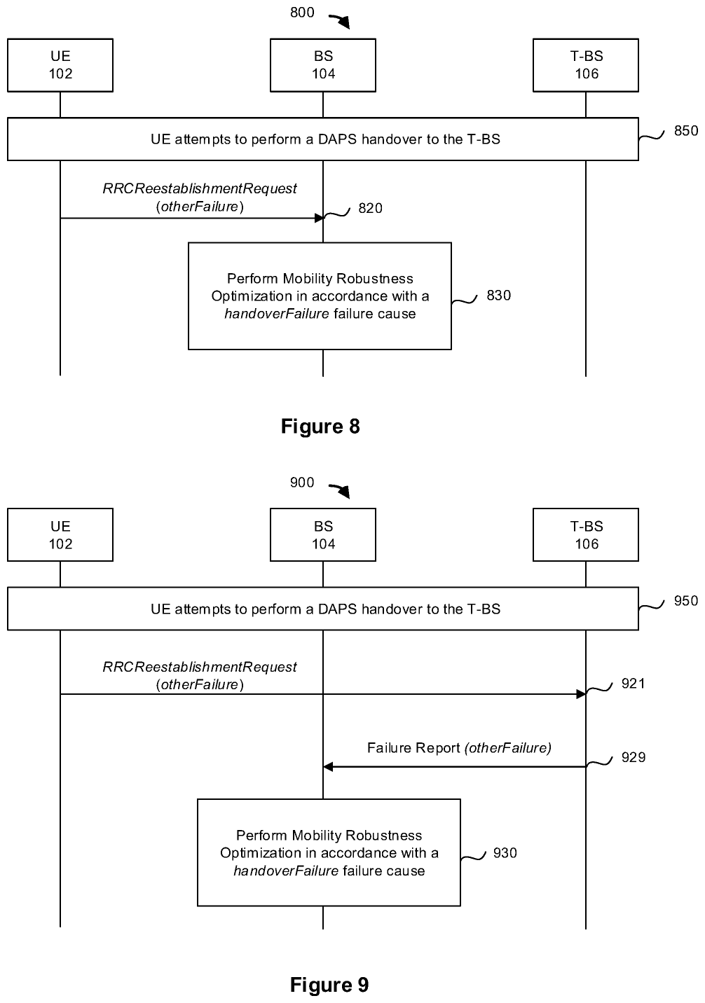

FIGS. 8-9 illustrate example messaging sequences corresponding to scenarios in which the base station 104 can use the techniques of this disclosure for supporting network optimization.

FIG. 8 illustrates a scenario 800 in which the base station 104 operates as a source base station, and the base station 106 operates as a target base station (T-BS). Initially, the BS 104 attempts 850 to perform a DAPS handover to the T-BS, similar to the DAPS handover attempt procedure 450. Before the BS 104 receives a DAPS failure indication (e.g., a FailureInformation message) from the UE 102 or a handover success indication from the T-BS 106 (e.g., a Handover Success message), the BS 104 receives 820 an RRCReestablishmentRequest message from the UE 102. The RRCReestablishmentRequest message the BS 104 receives 820 includes a failure cause corresponding to otherFailure, which conventionally indicates that the UE 102 has detected a RLF. However, in scenario 800, because the BS 104 receives 820 the RRCReestablishmentRequest message with cause otherFailure before receiving a DAPS handover success or failure indication, the BS 104 determines that the UE 102 detected a handover failure. As a result, the BS 104 performs 830 MRO in accordance with a failure cause corresponding to handover failure (e.g., handoverFailure) rather than an RLF (e.g., conventional otherFailure).

FIG. 9 illustrates a scenario 900 in which the base station 104 operates as a source base station, and the base station 106 operates as a target base station (T-BS). Initially, the BS 104 attempts 950 to perform a DAPS handover to the T-BS, similar to the DAPS handover attempt procedure 450. The UE 102 transmits 921 an RRCReestablishmentRequest message including a cause otherFailure to a second base station different from the BS 104. While FIG. 9 illustrates the UE 102 transmitting 921 the RRCReestablishmentRequest message to the T-BS 106, in some scenarios, the UE 102 can transmit the message to another base station of the RAN. Event 921 is similar to event 820, except that the UE 102 transmits 921 the RRCReestablishmentRequest message to a second base station rather than to the source BS 104. In response, the second base station (e.g., the T-BS 106 in scenario 900) transmits 929 a failure report (e.g., an RLF INDICATION or FAILURE INDICATION) including the failure cause otherFailure to the BS 104.

Similar to event 830, in response to receiving the otherFailure failure cause before receiving a DAPS handover success or failure indication, the BS 104 determines that the UE 102 detected a handover failure. As a result, the BS 104 performs 930 MRO in accordance with a failure cause corresponding to handover failure (e.g., handoverFailure) rather than an RLF (e.g., conventional otherFailure).

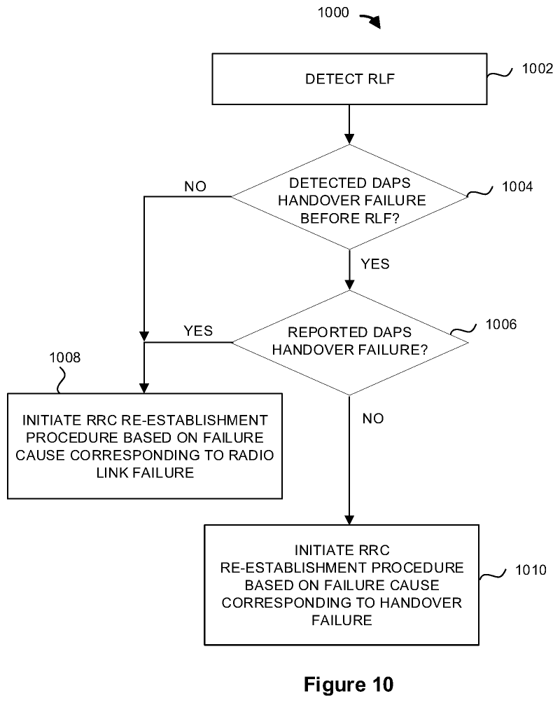

For further clarity, FIGS. 10-14 illustrate several example methods which the devices operating in the system 100 of FIG. 1 can implement to support network optimization.

FIG. 10 is a flow diagram depicting an example method 1000 implemented in a UE (e.g., UE 102) to indicate a DAPS failure to the network. For convenience, the method 1000 is discussed below with reference to the BS 104, the T-BS 106 and the UE 102, operating in the wireless communication system 100.

At block 1002, the UE 102 operating in connected mode with the BS 104 detects an RLF (e.g., event 614 or 714). At block 1004, the UE 102 determines whether it detected a DAPS handover failure to the T-BS 106 before the UE 102 detected the RLF. If the UE 102 did not detect a DAPS handover failure prior to detecting the RLF, then the flow proceeds to block 1008. At block 1008, the UE 102 initiates an RRC re-establishment procedure with the network indicating that the UE 102 detected an RLF (e.g., by sending an RRCReestablishmentRequest message to a base station including a failure cause otherFailure).

If the UE 102 detected a DAPS handover failure after detecting the RLF, the flow proceeds to block 1006. At block 1006, the UE 102 determines whether the UE 102 already reported the DAPS handover failure to the BS 104 (e.g., already successfully transmitted a FailureInformation message with a daps failure indication or an RRCReestablishmentRequest message with cause handoverFailure). If the UE 102 already reported the DAPS handover failure, the flow proceeds to block 1008, where the UE 102 initiates an RRC re-establishment procedure to indicate that the UE 102 detected an RLF. Otherwise, the flow proceeds to block 1010, where the UE 102 initiates an RRC re-establishment procedure based on a failure cause corresponding to handover failure by, for example, sending an RRCReestablishmentRequest message to a base station including a failure cause handoverFailure (e.g., event 619).

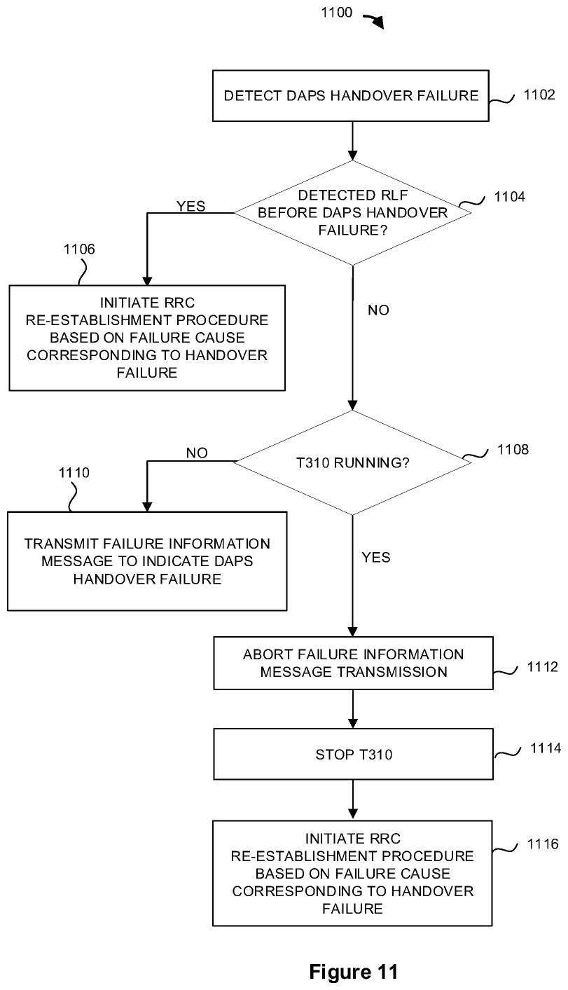

FIG. 11 is a flow diagram depicting an example method 1100 implemented in a UE (e.g., UE 102) to indicate a DAPS failure to the network. For convenience, the method 1100 is discussed below with reference to the BS 104, the T-BS 106 and the UE 102, operating in the wireless communication system 100.

At block 1102, the UE 102 operates in connected mode with the BS 104 and detects a DAPS handover failure (e.g., the timer T304 for DAPS handover expires) (e.g., event 511, 610, or 710). At block 1104, the UE 102 determines whether it detected an RLF in the radio connection with the BS 104 before the UE 102 detected the DAPS handover failure. If the UE 102 previously detected an RLF, the flow proceeds to block 1106, where the UE 102 initiates an RRC re-establishment procedure based on a failure cause corresponding to handover failure (e.g., by sending an RRCReestablishmentRequest message to a base station including a failure cause handoverFailure). Otherwise, the flow proceeds to block 1108.

At block 1108, the UE 102 determines whether a timer T310 is running. If the timer T310 is not running, then the flow proceeds to 1110, where the UE 102 transmits a FailureInformation message to the BS 104 indicating the DAPS failure. If the timer T310 is running, then the flow proceeds to block 1112.

At block 1112, the UE 102 aborts the FailureInformation message transmission (e.g., event 513). Next, at block 1114, the UE 102 stops the timer T310 (e.g., event 515). At block 1116, the UE 102 initiates an RRC re-establishment procedure based on a failure cause corresponding to handover failure (e.g., event 519).

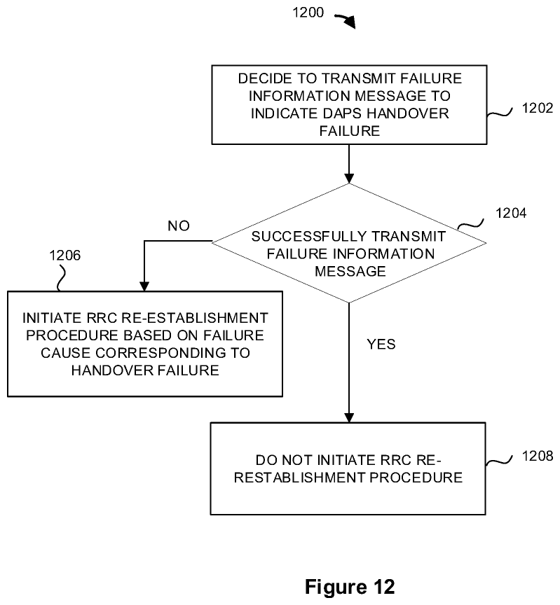

FIG. 12 is a flow diagram depicting an example method 1200 implemented in a UE (e.g., UE 102) to indicate a DAPS failure to the network. For convenience, the method 1200 is discussed below with reference to the BS 104, the T-BS 106 and the UE 102, operating in the wireless communication system 100.

At some time before block 1202, the UE 102 detects a DAPS handover failure (e.g., by detecting that the timer T304 expires) (e.g., event 511, 610, or 710). At block 1202, the UE 102 decides to transmit a FailureInformation message to the BS 104 to indicate the DAPS handover failure (e.g., event 610 or 710). The UE 102 then attempts to transmit the FailureInformation message to the BS 104 (e.g., event 616 or 716). At block 1204, the UE 102 checks whether the transmission was successful. If the UE 102 successfully transmits the FailureInformation message to the BS 104, then the flow proceeds to block 1208, where UE 102 does not initiate an RRC reestablishment procedure. If the UE 102 does not successfully transmit the FailureInformation to the BS 104, then the flow proceeds to block 1206. In one example, the UE 102 does not successfully transmit the FailureInformation to the BS 104 because the UE 102 detects an RLF in the BS 104. At block 1206, the UE 102 initiates an RRC re-establishment procedure based on a failure cause corresponding to handover failure (e.g., by sending an RRCReestablishmentRequest message to a base station including a failure cause handoverFailure) (e.g., event 619).

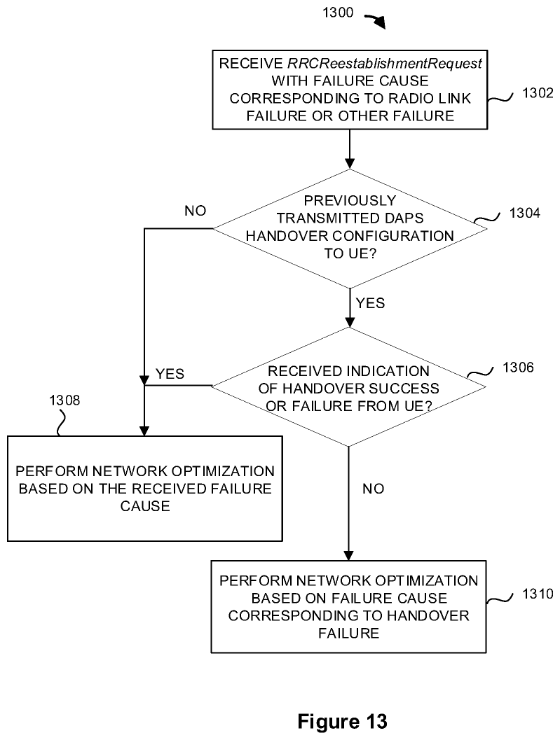

FIG. 13 is a flow diagram depicting an example method 1300 implemented in a BS (e.g., BS 104) to support network optimization. For convenience, the method 1300 is discussed below with reference to the BS 104, the T-BS 106 and the UE 102, operating in the wireless communication system 100.

At block 1302, the BS 104 receives, from the UE 102, an RRCReestablishmentRequest message with a failure cause indicating other failure or radio link failure (e.g., event 820). The BS 104 then checks 1304 whether the BS 104 previously transmitted a DAPS handover configuration to the UE 102 (e.g., as in event 406 of the DAPS handover attempt procedure 450). If not, then the flow proceeds to block 1308, where the BS 104 performs network optimization based on the received failure cause. If the BS 104 transmitted a DAPS handover configuration to the UE 102, then the flow proceeds to block 1306. At block 1306, the BS 104 checks whether it received an indication of a DAPS handover success or failure before receiving the RRCReestablishmentRequest message. If so, then the flow proceeds to block 1308. If not, then the flow proceeds to block 1310, where the BS 104 performs network optimization as if the received failure cause was handover failure (e.g., event 830).

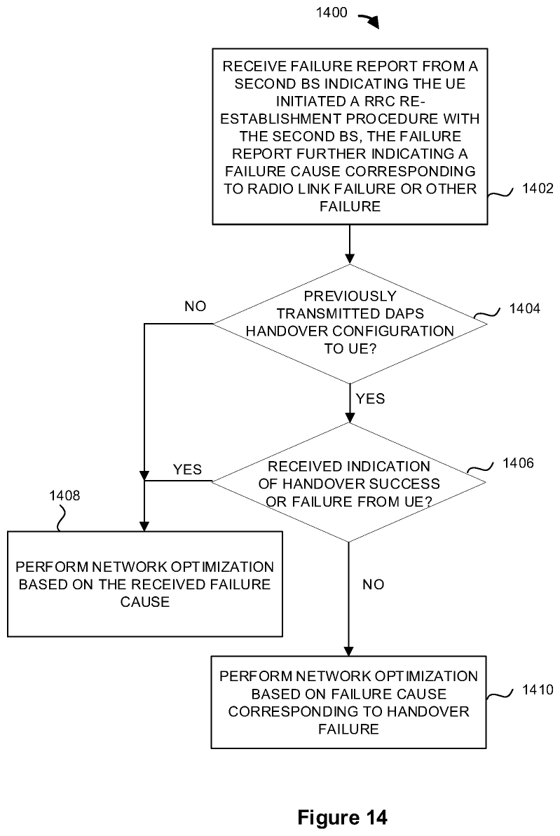

FIG. 14 is a flow diagram depicting an example method 1400 implemented in a BS (e.g., BS 104) to support network optimization. For convenience, the method 1400 is discussed below with reference to the BS 104, the T-BS 106 and the UE 102, operating in the wireless communication system 100.

At block 1402, the BS 104 receives, from a second BS (e.g., T-BS 106), a failure report (e.g., an RLF INDICATION message or a FAILURE INDICATION message) indicating that the second base station initiated an RRC re-establishment procedure with the second BS (e.g. event 929). The failure report further indicates a failure cause of “other failure” or “radio link failure”. At block 1404, the BS 104 checks whether the BS 104 previously transmitted a DAPS handover configuration to the UE 102 (e.g., as in event 406 of the DAPS handover attempt procedure 450). If not, then the flow proceeds to block 1408, where the BS 104 performs network optimization based on the received failure cause. If the BS 104 transmitted a DAPS handover configuration to the UE 102, then the flow proceeds to block 1406. At block 1406, the BS 104 checks whether it received an indication of a DAPS handover success or failure before receiving the failure report. If so, then the flow proceeds to block 1408. If not, then the flow proceeds to block 1410, where the BS 104 performs network optimization as if the received failure cause was handover failure (e.g., event 930).

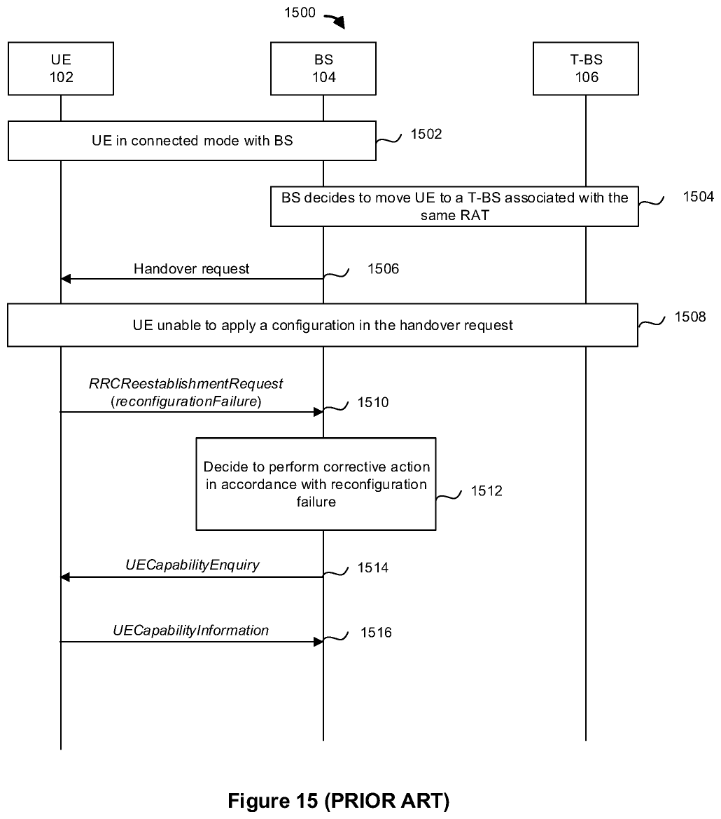

FIGS. 3-14 depict techniques for supporting improved error reporting and network optimization in DAPS handover scenarios. FIGS. 15-20 depict similar techniques in inter-RAT handover scenarios (i.e., handovers from a first RAT to a second RAT).

For context, FIG. 15 depicts a messaging sequence during an intra-RAT handover scenario 1500 in which the base station 104 operates as a source base station, and the base station 106 operates as a target base station (T-BS). The BS 104 and T-BS 106 are cells using the same RAT (e.g., NR or EUTRA). Initially, UE 102 is 1502 operates in connected mode with the BS 104. At a later time, the BS 104 decides 1504 to hand over the UE 102 to the T-BS 106. In response to this decision, the BS 104 transmits 1506 a handover request message to the UE 102 (e.g., an RRCReconfiguration message or an RRCConnectionReconfiguration message). The handover request message includes at least one configuration that the UE 102 can use to connect to the cell associated with the T-BS 106. While this disclosure generally refers to a “handover” sometimes also referred to as a reconfiguration with sync.

The UE 102 receives 1506 the handover request message and determines 1508 that it is unable to apply at least one configuration from the handover request message. In one example, the UE 102 determines that it is unable to apply the configuration because the UE 102 is unable to comply with any part of the configuration included in the handover request message. In another example, the UE 102 is unable to apply the configuration due to a protocol error in the information included in the handover request message.

In response to the determination 1508, the UE 102 transmits 1510 an RRCReestablishmentRequest (or a RRCConnectionReestablishmentRequest) message with a failure cause indicating a reconfiguration failure (e.g., reconfigurationFailure) to the BS 104. The BS 104 decides 1512 to perform corresponding corrective actions in response to the reconfiguration failure. In one example, the BS 104 may transmit 1514 a UECapabilityEnquiry message to UE 102 to request the latest UE capability information. In response to the UECapabilityEnquiry, the UE 102 transmits 1516 a UECapabilityInformation message to the BS 104 to update its capability (e.g., a UE-NR-Capability, a UE-MRDC-Capability, or a UE-EUTRA-Capability).

In another example, the BS 104 may include a UE parameters update transparent container in a DL NAS TRANSPORT message and transmit the message to the UE 102 to request the latest UE capability. In response to the DL NAS TRANSPORT message, the UE 102 may perform a register procedure, a routing area update procedure, or a tracking area update procedure, or may transmit a UL NAS TRANSPORT message with a UE parameters update transparent container to the BS 104 to update its capability.

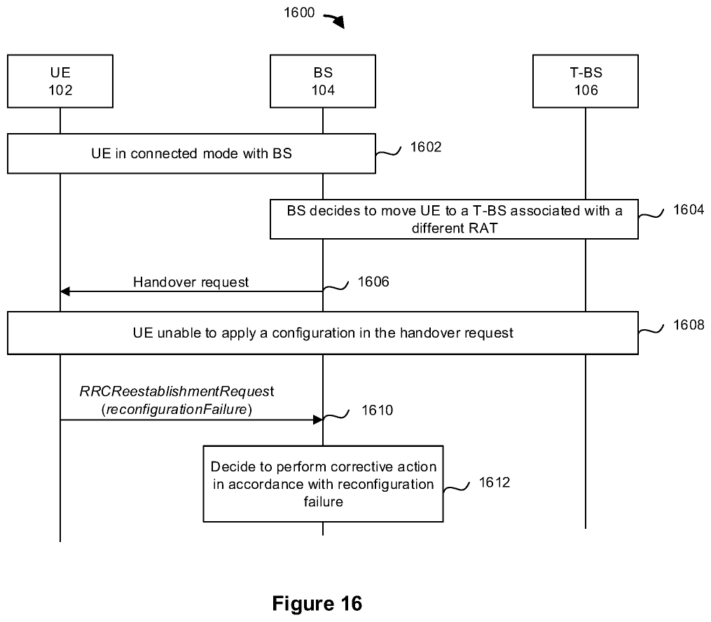

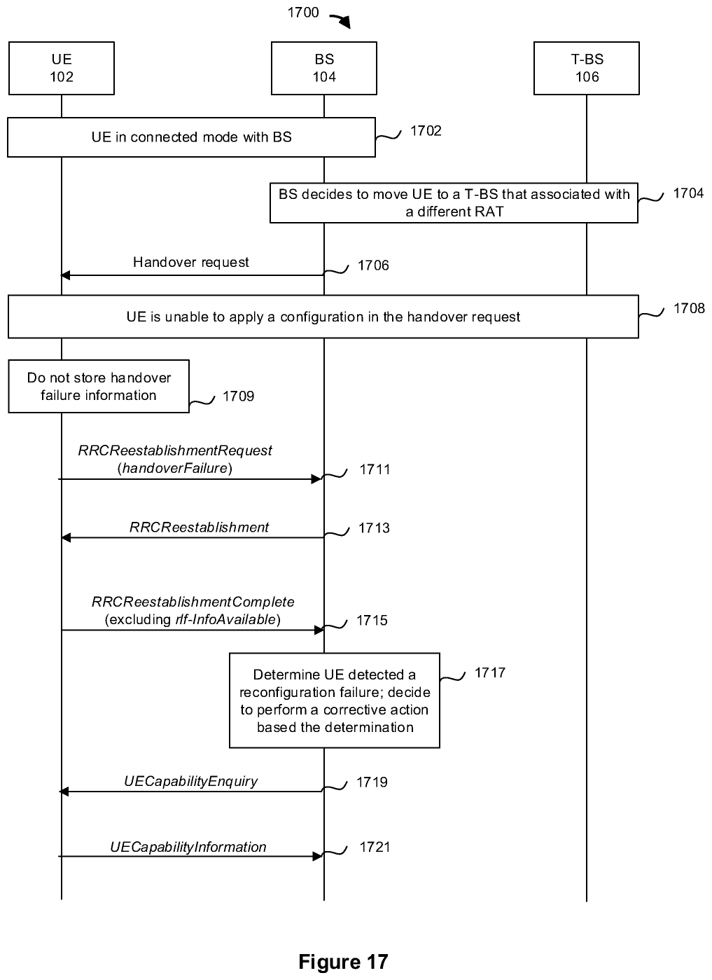

FIGS. 16-17 illustrate example messaging sequences corresponding to inter-RAT handover failure scenarios in which the UE 102 can use the techniques of this disclosure for supporting network optimization.

FIG. 16 illustrates an inter-RAT handover scenario 1600 in which the base station 104 operates as a source base station, and the base station 106 operates as a target base station (T-BS). The BS 104 and T-BS 106 are associated with cells of different RATs (e.g., NR or EUTRA). In some scenarios, the inter-RAT handover can involve a handover from a first cell to a second cell associated with the same base station but a different RAT. Initially, the UE 102 operates 1602 in connected mode with the BS 104. At a later time, the BS 104 decides 1604 to hand over the UE to the T-BS 106 associated with a different RAT. In response to this decision, the BS 104 transmits 1606 a handover request message to the UE 102 (e.g., an MobilityFromNRCommand message to hand over the UE 102 from NR to another RAT, or an MobilityFromEUTRACommand message to hand over the UE 102 from EUTRA to another RAT). The handover request message includes at least one configuration that the UE 102 can use to connect to the second cell associated with the different RAT.

The UE 102 receives 1606 this handover request message and determines 1608 that it is unable to apply at least one configuration from the handover request message. In one example, the UE 102 determines that it is unable to apply the configuration because the UE 102 is unable to comply with any part of the configuration included in the handover request message. In another example, the UE 102 is unable to apply the configuration due to a protocol error in the information included in the handover request message.

In response to the determination 1608, the UE 102 transmits 1610 an RRCReestablishmentRequest (or a RRCConnectionReestablishmentRequest) message with a failure cause indicating a reconfiguration failure (e.g., a reconfigurationFailure) to the BS 104. Rather than reporting a handover failure, for example, the UE 102 reports a reconfiguration failure to the network. More particularly, if the UE 102 is initiating a re-establishment procedure due to a failure to comply with a configuration in a handover request, such as a MobilityFromEUTRACommand or a MobilityFromNRCommand, then the UE 102 sets the failure cause (e.g., a reestablishmentCause) to a value indicating a reconfiguration failure (e.g., reconfigurationFailure). In this way, the UE 102 informs the network of the reconfiguration failure. and the network can perform network optimization or other suitable corrective action in response.

The BS 104 decides 1612 to perform corresponding corrective actions in response to the reconfiguration failure. In one example corrective action (not shown), the BS 104 may transmit a UECapabilityEnquiry message to the UE 102 to request the latest UE capability. In response to the UECapabilityEnquiry, the UE 102 transmits a UECapabilityInformation message to the BS 104 to update its capability (e.g., a UE-NR-Capability, a UE-MRDC-Capability, a UE-EUTRA-Capability, or an INTER RAT HANDOVER INFO).

In another example corrective action (not shown), the BS 104 may include a UE parameters update transparent container in a DL NAS TRANSPORT message and transmit the message to the UE 102 to request the latest UE capability. In response to the DL NAS TRANSPORT message, the UE 102 may perform a register procedure again, a routing area update procedure, or a tracking area update procedure, or may transmit a UL NAS TRANSPORT message with a UE parameters update transparent container to the BS 104 to update its capability.

FIG. 17 illustrates a scenario 1700 in which the base station 104 operates as a source base station, and the base station 106 operates as a target base station (T-BS). The BS 104 and T-BS 106 are associated with cells of different RATs (e.g., NR or EUTRA). In some scenarios, the inter-RAT handover can involve a handover from a first cell to a second cell associated with the same base station but a different RAT. Initially, the UE 102 operates 1702 in connected mode with the BS 104. At a later time, the BS 104 decides 1704 to hand over the UE to the T-BS 106 associated with different RAT. In response to this decision, the BS 104 transmits 1706 a handover request message to the UE 102 (e.g., a MobilityFromNRCommand message or a MobilityFromEUTRACommand message).

The UE 102 receives 1706 the handover request message and determines 1708 that it is unable to apply at least one configuration from the Handover Request message, similar to the determination 1608. In response to the determination 1708, the UE 102 determines 1709 not to store handover failure information and transmits 1711 an RRCReestablishmentRequest (or a RRCConnectionReestablishmentRequest) message including a failure cause corresponding to handover failure (e.g., handoverFailure) to the BS 104. After receiving the RRCReestablishmentRequest message from the UE 102, the BS 104 transmits 1713 an RRCReestablishment message to the UE 102. In response to the RRCReestablishment message, the UE 102 transmits 1715 an RRCReestablishmentComplete message to the BS 104. The RRCReestablishmentComplete message does not include an indication that handover failure information is available because the UE 102 did not store handover failure information at event 1709. In one example, the UE 102 does not include an rlf-InfoAvailable in the RRCReestablishmentComplete message. In another example, the UE 102 includes an rlf-InfoAvailable in the RRCReestablishmentComplete message, but does not set the connectionFailureType to ‘hof’ (e.g., the UE 102 can set the connectionFailureType to ‘rlf’).

In some implementations, the BS 104 transmits an RRCSetup message instead of an RRCReestablishment message at event 1713, and transmits an RRCSetupComplete message to the BS 104 at event 1715. The RRCSetupComplete message does not include an indication that handover failure information is available.

Because the message the BS 104 receives 1715 indicates that there is no handover failure information available, the BS 104 determines 1717 that the UE 102 detected a reconfiguration failure and decides 1717 to perform a corrective action based on the determination. For example, the BS 104 can transmit 1719 a UECapabilityEnquiry message to UE 102 to request the latest UE capability. In response to the UECapabilityEnquiry message, the UE 102 transmits 1721 a UECapabilityInformation message to the BS 104 to update its capability (e.g., a UE-NR-Capability, a UE-MRDC-Capability, a UE-EUTRA-Capability, or a INTER RAT HANDOVER INFO).

In another example, the BS 104 may include a UE parameters update transparent container in a DL NAS TRANSPORT message and transmit the message to the UE 102 to request the latest UE capability. In response to the DL NAS TRANSPORT message, the UE 102 may perform a register procedure, a routing area update procedure, or a tracking area update procedure, or may transmit a UL NAS TRANSPORT message with a UE parameters update transparent container to the BS 104 to update its capability.

For further clarity, FIGS. 18-20 illustrate several example methods that devices operating in the system 100 of FIG. 1 can implement to support network optimization.

FIG. 18 is a flow diagram depicting an example method 1800, which can be implemented in a UE (e.g., UE 102) to indicate a reconfiguration failure to the network. For convenience, the method 1800 is discussed below with reference to the BS 104, the T-BS 106 and the UE 102, operating in the wireless communication system 100.

At some time before block 1802, the UE 102 receives a handover request including a configuration for the UE 102 to use to connect to a cell associated with a T-BS 106 (e.g., event 1606 or 1706). At block 1802, the UE 102 determines that it is unable to complete an inter-RAT handover from the BS 104 to the T-BS 106 and decides to initiate an RRC re-establishment procedure (e.g., event 1608 or 1708). At block 1804, the UE 102 checks whether the timer T304 expired. The UE 102 previously started the timer T304 upon attempting to connect to the T-BS 106. If the timer T304 expired, then the flow proceeds to block 1808, where the UE 102 initiates the RRC re-establishment by transmitting an RRCReestablishmentRequest including the failure cause handoverFailure. If the timer T304 has not expired, then the flow proceeds to block 1806. At block 1806, UE 102 determines that the failure to complete the inter-RAT handover is due to a failure to apply a configuration associated with the T-BS 106, and initiates an RRC re-establishment procedure by transmitting an RRCReestablishmentRequest including the failure cause reconfigurationFailure (e.g., event 1610).

FIG. 19 is a flow diagram depicting an example method 1900 implemented in a UE (e.g., UE 102) to indicate a reconfiguration failure to the network. For convenience, the method 1900 is discussed below with reference to the BS 104, the T-BS 106 and the UE 102, operating in the wireless communication system 100.

At some time before block 1902, the UE 102 receives a handover request including a configuration the UE 102 is to use to connect to a cell associated with a T-BS 106 (e.g., event 1606 or 1706). At block 1902, the UE 102 determines that it is unable to complete an inter-RAT handover from the BS 104 to the T-BS 106 and decides to initiate an RRC re-establishment procedure (e.g., event 1608 or 1708). At block 1904, the UE 102 determines whether the UE 102 is unable to apply a configuration in the handover request. If so, then the flow proceeds to block 1906, where the UE 102 initiates an RRC re-establishment procedure by transmitting an RRCReestablishmentRequest including the failure cause reconfigurationFailure (e.g., event 1610). Otherwise, the flow proceeds to block 1908, where the UE 102 initiates an RRC re-establishment procedure by transmitting an RRCReestablishmentRequest including the failure cause handoverFailure.

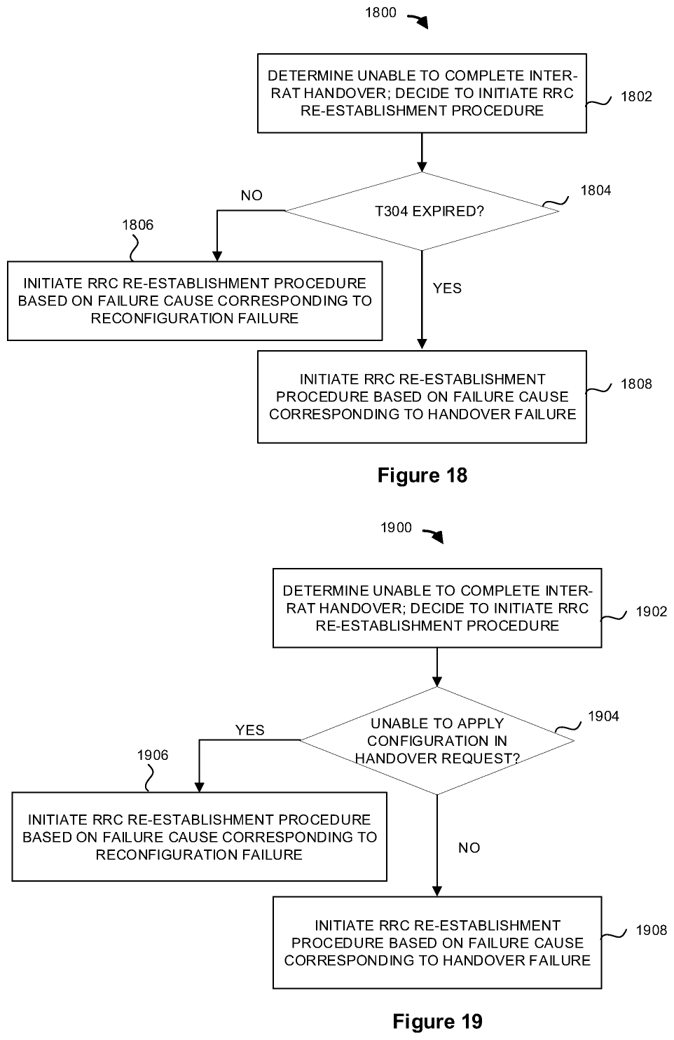

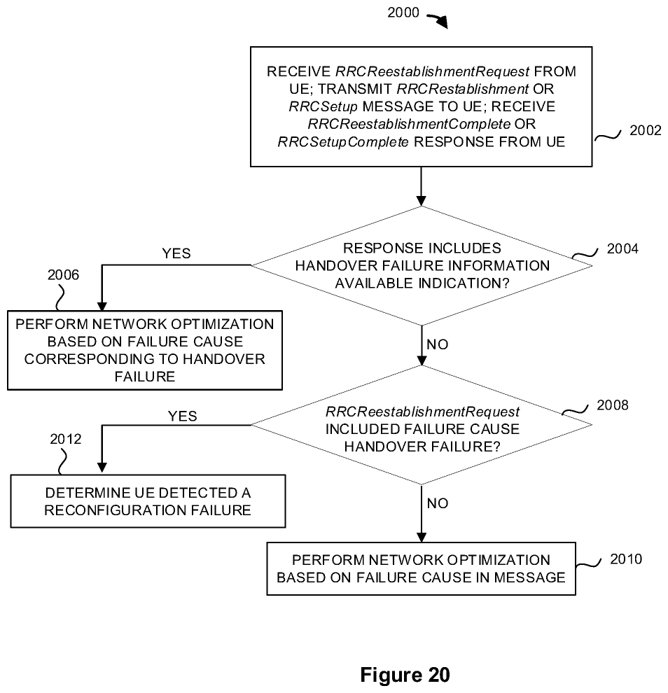

FIG. 20 is a flow diagram depicting an example method 2000 implemented in a BS (e.g., BS 104) to support network optimization. For convenience, the method 2000 is discussed below with reference to the BS 104, the T-BS 106 and the UE 102, operating in the wireless communication system 100.

At some point prior to block 2002, the BS 104 receives an RRCReestablishmentRequest from the UE 102 and transmits an RRCReestablishment message or an RRCSetup message to the UE 102 in response (e.g., events 1711 and 1713). At block 2002, the BS 104 receives an RRCReestablishmentComplete or an RRCSetupComplete from the UE 102 (e.g., event 1715). Next, at block 2004, the BS 104 checks 2004 whether the RRCReestablishmentComplete message or the RRCSetupComplete message includes an indication that handover failure information is available. If so, then the flow proceeds to block 2006, where the BS 104 performs network optimization based on a failure cause corresponding to handover failure (e.g., handoverFailure). Otherwise, the flow proceeds to block 2008.

At block 2008, the BS 104 checks whether a failure cause received in the previous RRCReestablishmentRequest corresponds to handover failure. If the failure cause is not a handover failure, then the flow proceeds to block 2010, where the BS 104 performs the network optimization according to received cause (e.g., optimization for RLF if the cause is otherFailure or RLF). If the cause is a handover failure, then the flow proceeds to block 2012. At block 2012, the BS 104 determines that the UE 102 detected a reconfiguration failure (e.g., event 1717). In response to the determination, the BS 104 can perform corrective actions to address the reconfiguration failure (e.g., event 1719)

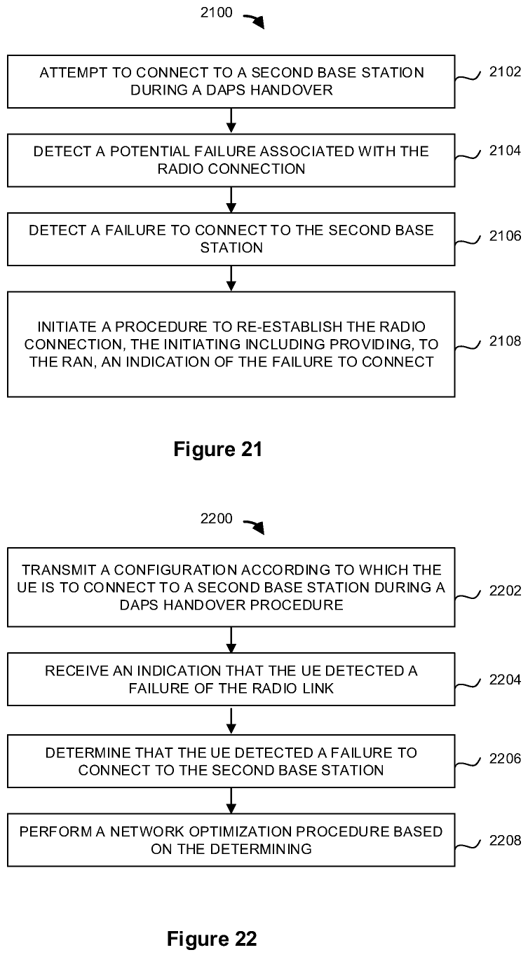

FIGS. 21-24 are flow diagrams of example methods that devices operating in the system 100 of FIG. 1 can implement to support network optimization, in DAPS handover failure scenarios or inter-RAT handover failure scenarios.

FIG. 21 is a flow diagram of an example method 2100 for supporting a DAPS handover, which can be implemented in a UE (e.g., the UE 102) of this disclosure as a set of instructions stored on a computer-readable medium and executable by processing hardware (e.g., the processing hardware 150). The UE is initially connected to a first base station (e.g., the BS 104) of a RAN.

At block 2102, the UE attempts to connect to a second base station (e.g., the BS 106 operating as a T-BS) during a DAPS handover (e.g., event 550, 650, 750, 850, 950). At block 2104, the UE detects a potential failure associated with the radio connection with the first base station (e.g., event 509, 614, or 714). For example, the UE may detect a synchronization problem and start a timer T310, or the UE may detect a RLF. At block 2106, the UE detects a failure to connect to the second base station (e.g., a DAPS handover failure or a reconfiguration with sync failure) (e.g., event 511, 610, or 710). Depending on the implementation and/or scenario, the blocks 2104 and 2106 may occur in different orders. At block 2108, the UE initiates a procedure to re-establish the radio connection, the initiating including providing, to the RAN (e.g., to the BS 104 or the T-BS 106), an indication of the failure to connect (e.g., by initiating an RRC re-establishment procedure by transmitting an RRCReestablishmentRequest including a failure cause corresponding to handoverFailure) (e.g., event 519 or 619).

FIG. 22 is a flow diagram of an example method 2200 for network optimization, which can be implemented in a base station (e.g., the BS 104) of this disclosure as a set of instructions stored on a computer-readable medium and executable by processing hardware (e.g., the processing hardware 130).

At block 2202, the base station transmits a configuration according to which the UE is to connect to a second base station (e.g., the BS 106 operating as a T-BS) during a DAPS handover procedure (e.g., event 406 of the DAPS handover attempt procedure 450, or any of procedures 550, 650, 750, 850, or 950). At block 2204, the base station receives an indication that the UE detected a failure of the radio link (e.g., event 820 or 929). At block 2206, the base station determines that the UE detected a failure to connect to the second base station. Next, at block 2208, the base station performs a network optimization procedure (e.g., MRO) based on the determining (e.g., event 830 or 930).

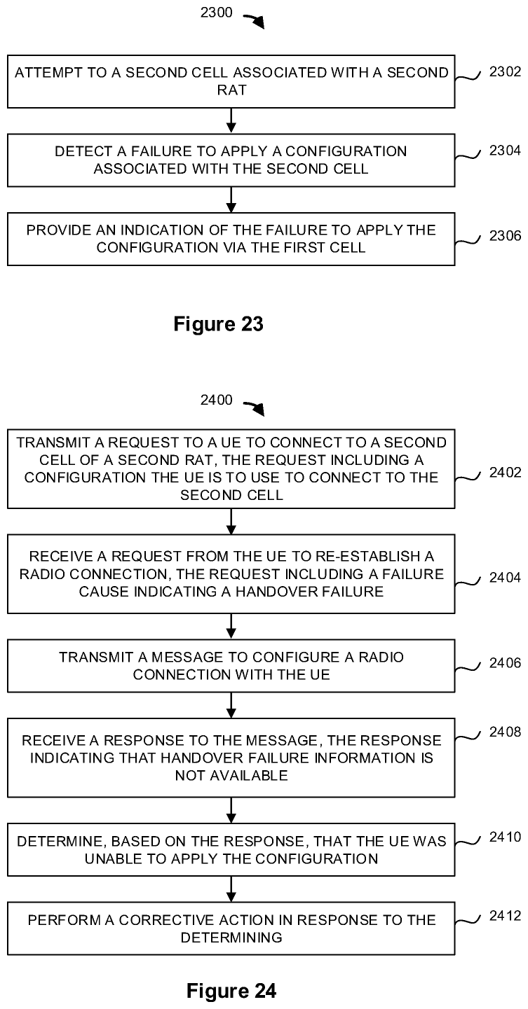

FIG. 23 is a flow diagram of an example method 2300 for supporting an inter-RAT handover, which can be implemented in a UE (e.g., the UE 102) of this disclosure as a set of instructions stored on a computer-readable medium and executable by processing hardware (e.g., the processing hardware 150). The UE is initially connected to a first cell associated with a first RAT (e.g., a cell 124 associated with the BS 104).

At block 2302, the UE attempts to connect to a second cell associated with a second RAT (e.g., a cell 126 associated with the BS 106) (e.g., in response to receiving a request in events 1606 or 1706). At block 2304, the UE detects a failure to apply a configuration associated with the second cell (e.g., event 1608 or 1708). At block 2306, the UE provides an indication of the failure to apply the configuration via the first cell (e.g., by initiating an RRC re-establishment procedure by transmitting an RRCReestablishmentRequest with failure cause corresponding to a reconfiguration failure) (e.g., event 1610).

FIG. 24 is a flow diagram of an example method 2400 for supporting an inter-RAT handover, which can be implemented in a base station (e.g., the BS 104) of this disclosure as a set of instructions stored on a computer-readable medium and executable by processing hardware (e.g., the processing hardware 130). The base station is associated with a first cell (e.g., the cell 124) of a first RAT.

At block 2402, the base station transmits a request to a UE to connect to a second cell of a second RAT, the request including a configuration the UE is to use to connect to the second cell (e.g., event 1606 or 1706). At block 2404, the base station receives a request from the UE to re-establish a radio connection, the request including a failure cause indicating a handover failure (e.g., event 1711). Next, at block 2406, the base station transmits a message to configure the radio connection with the UE (e.g., event 1713). At block 2408, the base station receives a response to the message, the response indicating that handover failure information is not available (e.g., event 1715). In response, at block 2410, the base station determines that the UE was unable to apply the configuration (e.g., event 1717). At block 2412, the base station performs a corrective action in response to the determining (e.g., event 1719).

Depending on the implementation and/or scenario, a UE (e.g., the UE 102) may perform a combination of the techniques disclosed above (e.g., a combination of the methods 2100 and 2300). For example, while performing method 2300, the UE 102 may detect a potential failure of a radio connection associated with the first cell. Similarly, a base station (e.g., the BS 104) may perform a combination of the techniques disclosed above (e.g., a combination of the methods 2200 and 2400).

The following list of examples reflects a variety of the embodiments explicitly contemplated by the present disclosure:

Example 1. A method for supporting a dual active protocol stack (DAPS) handover in a user equipment (UE) connected to a first base station of a radio access network (RAN), the method comprising: attempting, by processing hardware, to connect to a second base station of the RAN during the DAPS handover; detecting, by the processing hardware, a potential failure associated with a radio connection to the first base station; detecting, by the processing hardware, a failure to connect to the second base station; and initiating, by the processing hardware, a procedure to re-establish the radio connection, the initiating including providing, to the RAN, an indication of the failure to connect.

Example 2. The method of example 1, wherein detecting the potential failure includes: detecting the potential failure before detecting the failure to connect to the second base station.

Example 3. The method of example 2, wherein detecting the potential failure includes: detecting a synchronization error related to the radio connection.

Example 4. The method of any of examples 2-3, further comprising: starting, by the processing hardware, a timer in response to detecting the potential failure; and wherein detecting the failure to connect to the second base station includes: detecting the failure to connect to the second base station while the timer is running.

Example 5. The method of example 4, further comprising: stopping, by the processing hardware, the timer in response to detecting the failure to connect to the second base station.

Example 6. The method of example 2, wherein detecting the potential failure includes: detecting a radio link failure with the first base station before detecting the failure to connect to the second base station.

Example 7. The method of example 1, wherein detecting the potential failure includes: detecting a radio link failure with the first base station after detecting the failure to connect to the second base station and before reporting to the first base station the failure to connect to the second base station.

Example 8. The method of example 7, wherein detecting the radio link failure includes: detecting a failure to successfully transmit a dedicated message for reporting the failure to connect.

Example 9. The method of any of examples 1-8, wherein providing the indication includes: transmitting a request to re-establish the radio connection, the request indicating a handover failure as a failure cause.

Example 10. The method of any of examples 1-9, wherein detecting the failure to connect includes: detecting a failure of the DAPS handover.

Example 11. A method for network optimization in a first base station in communication with a user equipment (UE) via a radio link, the method comprising: transmitting, by processing hardware, a configuration according to which the UE is to connect to a second base station during a dual active protocol stack (DAPS) handover procedure; receiving, by the processing hardware, an indication that the UE detected a failure of the radio link; determining, by the processing hardware, that the UE detected a failure to connect to the second base station; and performing, by the processing hardware, a network optimization procedure based on the determining.

Example 12. The method of example 11, wherein receiving the indication includes: receiving, from the UE a request to re-establish a radio connection with the UE, the request including a radio link failure as a failure cause.

Example 13. The method of example 11, wherein receiving the indication includes: receiving, from the second base station, an indication that the second base station received a request to re-establish a radio connection with the UE, the request including a radio link failure as a failure cause.

Example 14. The method of any of examples 11-13, wherein determining that the UE detected the failure to connect to the second base station includes: prior to receiving an indication that the UE completed or failed the DAPS handover, receiving the indication that the UE detected the failure of the radio link.

Example 15. The method of any of examples 11-14, wherein performing the network optimization includes: performing a Mobility Robustness Optimization (MRO).

Example 16. The method of any of examples 11-15, wherein transmitting the configuration includes: transmitting the configuration in a message conforming to a protocol for controlling radio resources.

Example 17. A method, in a user equipment (UE) connected to a first cell associated with a first radio access technology (RAT), for supporting a handover to a second cell associated with a second RAT, the method comprising: attempting, by processing hardware, to connect to the second cell; detecting, by the processing hardware, a failure to apply a configuration associated with the second cell; and providing, by the processing hardware, an indication of the failure to apply the configuration via the first cell.

Example 18. The method of example 17, wherein providing the indication includes: transmitting a request to re-establish a radio connection, the request including a failure cause indicating a reconfiguration failure.

Example 19. The method of any of examples 17-18, wherein detecting the failure includes: determining the UE is unable to apply the configuration.

Example 20. The method of any of examples 17-18, wherein detecting the failure includes: starting a timer in response to attempting to connect to the second cell; and determining the UE is unable to connect to the second cell before the timer expires.

Example 21. The method of any of examples 17-20, further comprising: receiving, by the processing hardware, the configuration associated with the second cell in a handover request message.

Example 22. The method of example 21, wherein receiving the configuration includes receiving the configuration in a MobilityFromNRCommand or a MobilityFromEUTRACommand.

Example 23. The method of any of examples 17-22, wherein the first cell and the second cell are associated with different base stations.

Example 24. The method of any of examples 17-23, further comprising: detecting, by the processing hardware, a potential failure of a radio connection associated with the first cell.

Example 25. A user equipment (UE) comprising processing hardware and configured to implement a method according to any of examples 1-10 or 17-24.

Example 26. A method for supporting an inter-RAT handover in a base station supporting a first cell of a first radio access technology (RAT), the method comprising: transmitting, by processing hardware, to a user equipment (UE), a request for the UE to connect to a second cell of a second RAT, the request including a configuration the UE is to use to connect to the second cell; receiving, by the processing hardware, a request from the UE to re-establish a radio connection, the request including a failure cause indicating a handover failure; transmitting, by the processing hardware, a message to configure the radio connection with the UE; receiving, by the processing hardware, a response to the message, the response indicating that handover failure information is not available; determining, by the processing hardware and based on the response, that the UE was unable to apply the configuration; and performing, by the processing hardware, a corrective action in response to the determining.

Example 27. The method of example 26, wherein performing the corrective action includes: transmitting a request to the UE for capability information associated with the UE.

Example 28. The method of any of examples 26-27, wherein transmitting the message to configure the radio connection includes: transmitting a message to re-establish the radio connection with the UE.

Example 29. The method of any of examples 26-27, wherein transmitting the message to configure the radio connection includes: transmitting a message to setup a new radio connection with the UE.

Example 30. The method of any of examples 26-29, wherein the first cell and the second cell are associated with different base stations.

Example 31. A base station comprising processing hardware and configured to implement a method according to any of examples 11-16 or 26-30.

The following description may be applied to the description above.

In some implementations, the RRCReconfiguration message can be an RRCConnectionReconfiguration message and the RRCReconfigurationComplete can be an RRCConnectionReconfigurationComplete message.

In some implementations, the RRCReconfiguration can be generated by the BS 104 or the T-BS 106. In some implementations, the RRCReestablishmentRequest message can be an RRCConnectionReestablishmentRequest message, the RRCReestablishment message can be an RRCConnectionReestablishment message, and the RRCReestablishmentComplete can be an RRCConnectionReestablishmentComplete message.

In some implementations, the one or more configurations for the UE 102 to perform the random access procedure may configure a 2-step random access. In another implementation, the random access configuration may configure a 4-step random access. In yet another implementation, the random access configuration may configure a contention-base random access or a contention-free random access. The UE 102 may transmit the RRCReconfigurationComplete or RRCReestablishmentRequest message to the cell in the random access procedure or after successfully completing the random access procedure. The cell that receives the RRCReestablishmentRequest can be the same as or different from a cell where the UE detects the RLF.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

The following additional considerations are also contemplated by this disclosure:

TS 38.331 v16.0.0 can be modified as follows:
5.3.5.8.3 T304 expiry (Reconfiguration with sync Failure)
The UE shall:
1> if T304 of the MCG expires:
   2> release dedicated preambles provided in rach-ConfigDedicated if configured;
   2> release dedicated msgA PUSCH resources provided in rach-ConfigDedicated if configured;
   2> store the following handover failure information in VarRLF-Report by setting its fields as follows:
      3> clear the information included in VarRLF-Report, if any;
      3> set the plmn-IdentityList to include the list of EPLMNs stored by the UE (i.e. includes the RPLMN);
      3> set the measResultLastServCell to include the RSRP, RSRQ and the available SINR, of the source PCell based on the available SSB and CSI-RS measurements collected up to the moment the UE detected handover failure;
      3> set the ssbRLMConfigBitmap and/or csi-rsRLMConfigBitmap in measResultLastServCell to include the radio link monitoring configuration of the source PCell;
      3> for each of the configured measObjectNR in which measurements are available;
         4> if the SS/PBCH block-based measurement quantities are available;
         5> set the measResultListNR in measResultNeighCells to include all the available measurement quantities of the best measured cells associated to the measObjectNR, other than the source PCell, ordered such that the cell with highest SS/PBCH block RSRP is listed first if SS/PBCH block RSRP measurement results are available, otherwise the cell with highest SS/PBCH block RSRQ is listed first if SS/PBCH block RSRQ measurement results are available, otherwise the cell with highest SS/PBCH block SINR is listed first, based on the available SS/PBCH block based measurements collected up to the moment the UE detected handover failure;
         6> for each neighbour cell included, include the optional fields that are available;
         4> if the CSI-RS based measurement quantities are available;
         5> set the measResultListNR in measResultNeighCells to include all the available measurement quantities of the best measured cells, other than the source PCell, ordered such that the cell with highest CSI-RS RSRP is listed first if CSI-RS RSRP measurement results are available, otherwise the cell with highest CSI-RS RSRQ is listed first if CSI-RS RSRQ measurement results are available, otherwise the cell with highest CSI-RS SINR is listed first, based on the available CSI-RS based measurements collected up to the moment the UE detected handover failure;
         6> for each neighbour cell included, include the optional fields that are available;
      3> for each of the configured EUTRA frequencies in which measurements are available;
         4> set the measResultListEUTRA in measResultNeighCells to include the best measured cells ordered such that the cell with highest RSRP is listed first if RSRP measurement results are available, otherwise the cell with highest RSRQ is listed first, and based on measurements collected up to the moment the UE detected radio link failure;
         5> for each neighbour cell included, include the optional fields that are available;
   NOTE 0: The measured quantities are filtered by the L3 filter as configured in the mobility measurement configuration. The measurements are based on the time domain measurement resource restriction, if configured. Blacklisted cells are not required to be reported.
      3> if detailed location information is available, set the content of the LocationInfo as follows:
         4> if available, set the commonLocationInfo to include the detailed location information;
         4> if available, set the bt-LocationInfo to include the Bluetooth measurement results, in order of decreasing RSSI for Bluetooth beacons;
         4> if available, set the wlan-LocationInfo to include the WLAN measurement results, in order of decreasing RSSI for WLAN APs;
         4> if available, set the sensor-LocationInfo to include the sensor measurement results;
      3> set the failedPCellId to the global cell identity and tracking area code, if available, and otherwise to the physical cell identity and carrier frequency of the target PCell of the failed handover;
      3> include previousPCellId and set it to the global cell identity and tracking area code of the PCell where the last RRCReconfiguration message including reconfigurationWithSync was received;
      3> set the timeConnFailure to the elapsed time since reception of the last RRCReconfiguration message including the reconfigurationWithSync;
      3> set the connectionFailureType to hof;
      3> set the c-RNTI to the C-RNTI used in the source PCell;
      3> set the absoluteFrequencyPointA to indicate the absolute frequency of the reference resource block associated to the random-access resources;
      3> set the locationAndBandwidth and subcarrierSpacing associated to the UL BWP of the random-access resources;
      3> set the msg1-FrequencyStart, msg1-FDM and msg1-SubcarrierSpacing associated to the random-access resources;
      3> set perRAInfoList to indicate random access failure information as specified in 5.3.10.3;
   2> if dapsConfig is configured for any DRB, radio link failure is not detected in the source PCell, according to subclause 5.3.10.3 and T310 is not running:
      3> release target PCell configuration;
      3> reset target MAC and release the target MAC configuration;
      3> for each DRB with a DAPS PDCP entity:
         4> release the RLC entity and the associated logical channel for the target;
         4> reconfigure the PDCP entity to normal PDCP as specified in TS 38.323 [5];
      3> for each SRB:
         4> if the masterKeyUpdate was not received:
         5> configure the PDCP entity for the source with the same state variables as the PDCP entity for the target;
         4> release the PDCP entity for the target;
         4> release the RLC entity and the associated logical channel for the target;
      3> release the physical channel configuration for the target;
      3> revert back to the SDAP configuration used in the source;
      3> discard the keys used in target (the K_{gNB} key, the S-K_{gNB} key, the S-K_{eNB} key, the K_{RRCenc} key, the K_{RRcint} key, the K_{UPint} key and the K_{UPenc} key), if any;
      3> resume suspended SRBs in the source;
      3> for each DRB without a DAPS PDCP entity:
         4> revert back to the UE configuration used for the DRB in the source, includes PDCP, RLC states variables, the security configuration and the data stored in transmission and reception buffers in PDCP and RLC entities;
      3> revert back to the UE RRM configuration used in the source;
      3> initiate the failure information procedure as specified in subclause 5.7.5 to report DAPS handover failure.
   2> else:
      3> revert back to the UE configuration used in the source PCell;
      3> initiate the connection re-establishment procedure as specified in subclause 5.3.7.
   NOTE 1: In the context above, “the UE configuration” includes state variables and parameters of each radio bearer.
1> else if T304 of a secondary cell group expires:
   2> if MCG transmission is not suspended:
      3> release dedicated preambles provided in rach-ConfigDedicated, if configured;
      3> initiate the SCG failure information procedure as specified in subclause 5.7.3 to report SCG reconfiguration with sync failure, upon which the RRC reconfiguration procedure ends;
   2> else:
      3> initiate the connection re-establishment procedure as specified in subclause 5.3.7;
1> else if T304 expires when RRCReconfiguration is received via other RAT (HO to NR failure):
   2> reset MAC;
   2> perform the actions defined for this failure case as defined in the specifications applicable for the other RAT.
      TS 38.331 v16.0.0 further can be modified as follows:
      5.7.5.x Failure to deliver FailureInformation message
      The UE shall:
1> if initiated FailureInformation to provide DAPS failure information:
   2> initiate the connection re-establishment procedure as specified in 5.3.7;
1> else:
   2> perform the radio link failure related actions as specified in 5.3.10.
      5.3.7.4 Actions related to transmission of RRCReestablishmentRequest message
      The UE shall set the contents of RRCReestablishmentRequest message as follows:
      . . .
1> set the reestablishmentCause as follows:
   2> if the re-establishment procedure was initiated due to reconfiguration failure as specified in 5.3.5.8.2:
      3> set the reestablishmentCause to the value reconfigurationFailure;
   2> else if the re-establishment procedure was initiated due to reconfiguration with sync failure as specified in 5.3.5.8.3 (intra-NR handover failure) or 5.4.3.5 (inter-RAT mobility from NR failure) or 5.7.5.x (Failure to deliver FailureInformation):
      3> set the reestablishmentCause to the value handoverFailure; 2> else:
      3> set the reestablishmentCause to the value otherFailure;
         TS 38.331 v16.0.0 further can be modified as follows:
         5.3.7.4 Actions related to transmission of RRCReestablishmentRequest message
         The UE shall set the contents of RRCReestablishmentRequest message as follows:
         . . .
1> set the reestablishmentCause as follows:
   2> if the re-establishment procedure was initiated due to reconfiguration failure as specified in 5.3.5.8.2 or 5.4.3.5:
      3> set the reestablishmentCause to the value reconfigurationFailure;
   2> else if the re-establishment procedure was initiated due to reconfiguration with sync failure as specified in 5.3.5.8.3 (intra-NR handover failure) or 5.4.3.5 (inter-RAT mobility from NR failure):
      3> set the reestablishmentCause to the value handoverFailure; 2> else:
      3> set the reestablishmentCause to the value otherFailure;
         TS 36.331 further can be modified as follows:
         5.3.7.4 Actions related to transmission of RRCConnectionReestablishmentRequest message
         Except for NB-IoT, if the procedure was initiated due to radio link failure or handover failure, the UE shall:
1> set the reestablishmentCellId in the VarRLF-Report to the global cell identity of the selected cell;
Editor's Note: FFS: The re-establishment cell id is also included in the RLF report for NB-IoT.
   The UE shall set the contents of RRCConnectionReestablishmentRequest message as follows:
. . .
1> set the reestablishmentCause as follows:
   2> if the re-establishment procedure was initiated due to reconfiguration failure as specified in 5.3.5.5 (the UE is unable to comply with the reconfiguration) or 5.4.3.5 (the UE is unable to comply with MobilityFromEUTRACommand):
      3> set the reestablishmentCause to the value reconfigurationFailure;
   2> else if the re-establishment procedure was initiated due to handover failure as specified in 5.3.5.6 (intra-LTE handover failure) or 5.4.3.5 (inter-RAT mobility from EUTRA failure):
      3> set the reestablishmentCause to the value handoverFailure; 2> else:
      3> set the reestablishmentCause to the value otherFailure;

1. A method for supporting a dual active protocol stack (DAPS) handover in a user equipment (UE) connected to a first base station of a radio access network (RAN), the method comprising:
attempting, by the UE, to connect to a second base station of the RAN during the DAPS handover;
detecting, by the UE, a potential failure associated with a radio connection to the first base station;
detecting, by the UE, a failure to connect to the second base station; and
initiating, by the UE, a procedure to re-establish the radio connection;
transmitting, by the UE to the RAN, a radio link failure report including an indication of the failure to connect to the second base station.

2. The method of claim 1, wherein the detecting of the potential failure includes:
detecting the potential failure before detecting the failure to connect to the second base station.

3. The method of claim 2, wherein the detecting of the potential failure includes:
detecting a synchronization error related to the radio connection.

4. The method of claim 2, further comprising:
starting, by the processing hardware, a timer in response to detecting the potential failure;
and wherein detecting the failure to connect to the second base station includes: detecting the failure to connect to the second base station while the timer is running.

5. The method of claim 2, wherein the detecting of the potential failure includes:
detecting a radio link failure with the first base station before detecting the failure to connect to the second base station.

6. The method of claim 1, wherein:
the detecting of the potential failure includes:
detecting a radio link failure with the first base station after the detecting of the failure to connect to the second base station and before the reporting to the first base station of the failure to connect to the second base station; and
the detecting of the radio link failure includes:
detecting a failure to successfully transmit a dedicated message for reporting the failure to connect.

7. The method of claim 1, wherein the transmitting of the radio link failure report includes:
transmitting an rlf-Report including the indication.

8. The method of claim 7, wherein the transmitting of the rlf-Report includes:
transmitting the rlf-Report including a connectionFailureType field set to a value that indicates the failure to connect to the second base station.

9. The method of claim 1, wherein the detecting of the failure to connect includes:
detecting a failure of the DAPS handover.

10. A user equipment (UE) configured to support a dual active protocol stack (DAPS) handover when connected to a first base station of a radio access network (RAN), the UE comprising:
processing hardware configured to implement;
a first module to provide a radio interface; and
a second module configured to:
attempt to connect to a second base station of the RAN during the DAPS handover,
detect a potential failure associated with a radio connection to the first base station,
detect a failure to connect to the second base station, and
initiate a procedure to re-establish the radio connection.

11. A method for network optimization in a first base station in communication with a user equipment (UE) via a radio link, the method comprising:
transmitting, by the first base station, a configuration according to which the UE is to connect to a second base station during a dual active protocol stack (DAPS) handover procedure;
receiving, by the first base station, an indication that the UE detected a failure of the radio link and that the UE failed to connect to the second base station; and
performing, by the first base station, a network optimization procedure based on the indication.

12. The method of claim 11, wherein the receiving of the indication includes at least one of:
receiving, from the UE a request to re-establish a radio connection with the UE, the request including a failure cause set to radio link failure (RLF); or
receiving, from the second base station, a message indicating that the second base station received a request to re-establish a radio connection with the UE, the request including a failure cause set to RLF.

13. The method of claim 11, wherein the receiving of the indication includes:
receiving, from the UE, a radio link failure report including an indication of the failure to connect to the second base station.

14. The method of claim 11, wherein the performing of the network optimization includes:
performing a Mobility Robustness Optimization (MRO).

15. A first base station configured to implement network optimization when in a communication with a user equipment (UE), the first base station comprising processing hardware configured to implement
a first module to provide a radio interface; and
a second module configured to:
transmit a configuration according to which the UE is to connect to a second base station during a dual active protocol stack (DAPS) handover procedure;
receive an indication that the UE detected a failure of the radio link and that the UE failed to connect to the second base station and
perform a network optimization procedure based on the indication.

16. The UE of claim 10, wherein to detect the potential failure, the second module is configured to:
detect the potential failure before detecting the failure to connect to the second base station.

17. The UE of claim 10, wherein to detect the potential failure, the second module is configured to:
detect a synchronization error related to the radio connection.

18. The UE of claim 17, wherein the second module is further configured to:
start a timer in response to detecting the potential failure;
and wherein detecting the failure to connect to the second base station includes detecting the failure to connect to the second base station while the timer is running

19. The UE of claim 10, wherein to detect the potential failure, the second module is configured to:
detect a radio link failure with the first base station before detecting the failure to connect to the second base station.

20. The UE of claim 10, wherein the detecting of the potential failure includes:
detecting a radio link failure with the first base station after the detecting of the failure to connect to the second base station and before the reporting to the first base station of the failure to connect to the second base station; and
the detecting of the radio link failure includes detecting a failure to successfully transmit a dedicated message for reporting the failure to connect
